(19) United States
(12) Patent Application Publication
(10) Pub. No.: US 2015/0347246 A1
(43) Pub. Date: Dec. 3, 2015

(54) AUTOMATIC-FAULT-HANDLING CACHE SYSTEM, FAULT-HANDLING PROCESSING METHOD FOR CACHE SERVER, AND CACHE MANAGER

(71) Applicant: HITACHI, LTD., Tokyo (JP)

(72) Inventors: Genki MATSUI, Tokyo (JP); Daisuke ITO, Tokyo (JP)

(21) Appl. No.: 14/649,738

(22) PCT Filed: Nov. 22, 2013
(86) PCT No.: PCT/JP2013/081464

§ 371 Date: Jun. 4, 2015

(30) Foreign Application Priority Data
Dec. 5, 2012 (JP) 2012-266139

(51) Int. Cl. G06F 11/20; G06F 3/06

(52) U.S. Cl. CPC G06F 11/203; G06F 3/0619; G06F 3/0653; G06F 3/0635; G06F 3/0683; G06F 2201/85; G06F 2201/885

(57) ABSTRACT

The relationship between cache servers and backup cache servers is dynamically managed, and when a fault has arisen, a second cache server that is close in terms of distance to a PBR router that is forwarding traffic to a first cache server at which the fault has arisen is used as a backup cache server. Also, a module or a device having functionality as a cache manager and a cache agent is prepared, and with the trigger being the detection of a fault in the first cache server, the cache agent automatically alters the traffic forwarding destination of the PBR router, which is forwarding traffic to the first cache server at which the fault has arisen, to be the second cache server that is close in terms of distance to the PBR router.

### TECHNICAL FIELD

The present invention is a technique that relates to a cache server on a network, and relates more particularly to an automatic-fault-handling cache system for forwarding traffic of an end user to another cache server when a cache server that the end user was using is stopped, and a fault-handling processing method for a cache server.

### BACKGROUND ART

For the purpose of traffic reduction in a network, a cache system is used in which a cache server is placed in the vicinity of an end user and data is returned to the end user from the cache server. In the cache system, a large number of cache servers are installed in the network in a distributed manner, and thus the costs required for the operation and management of the cache servers and for fault-handling at the time of a fault are large. In particular, fault-handling of the cache server needs to be performed without cutting off communication that passes through the cache server, which takes time and effort such as changing settings of a router and requires high costs. Therefore, an automatic-fault-handling system is used for the purpose of reduction in the costs required for fault-handling when a fault arises at a cache server.

For example, an automatic-fault-handling system that prepares a backup system server for an active system server and switches to the backup system server when a fault arises at the active system server is commonly used. Specifically, the automatic-fault-handling system is described as a conventional technique in Patent Literature 1. That is, Patent Literature 1 discloses that a fail over system 100 includes an arithmetic processing unit including an active node 110 and an inactive node 1202, that a process is usually executed on the active node 110 while the inactive node 120 monitors the process, all the operations of the active node 110 will be shut down on detection of a fault at the active node 110, and the fail over mechanism starts in which the inactive node 120 becomes an active new node and resumes all activities.

In addition, an automatic-fault-handling system is commonly used for allocating processing only to a normal server (a server at which a fault has not arisen) instead of allocating a request to a server at which a fault has arisen when a load balancer device for performing fault monitoring of a plurality of servers detects a fault at the server. Specifically, Patent Literature 2 describes the following system. A server requires high usability, and when there is a plurality of servers and a fault arises at one of the plurality of servers, the system moves to fail over in order to continue processing in spite of the fault. In such a situation, a load balancer device is commonly used in order to distribute work to each of the plurality of servers. When any one of the servers fails, the load balancer device detects the fault and tries to compensate the fault by distributing all the requests to the remaining servers.

Furthermore, Patent Literature 3 discloses a proxy server selection device that automatically selects a proxy server optimal for a client in consideration of the network load, server load, and client position.

### PRIOR ART LITERATURES

### Patent Literatures

PTL 1: US 2003/0097610 A1

PTL 2: US 2006/0294207 A1

PTL 3: Japanese Patent Application Laid-Open No. 2001-273225

### SUMMARY OF THE INVENTION

### Technical Problem to be Solved by the Invention

When the use of the above-mentioned conventional systems in the cache system is considered, the following problems and issues have been found out by us, the inventors.

First, in the system using the active system server and backup system server described in Patent Literature 1, at least one backup cache server needs to be installed for one or more active cache servers. However, there is a first problem that the active system server and the backup system server have previously registered fixed relationship, and that installment of the backup cache server for every one or more units of a lot of cache servers installed on the network will increase the facility costs and operating costs.

Next, in the second system using the load balancer device described in Patent Literature 2, the server and the load balancer have previously registered fixed relationship. If only one load balancer device is installed, the load balancer device will become a single fault. For this reason, it is necessary to install a plurality of load balancer devices for one or more cache servers in order to provide the load balancer device with redundancy. In this case, however, there is a second problem that the facility costs and operating costs will increase.

In addition, the number of cache servers that can be managed by the load balancer device is limited by throughput of the load balancer device. Specifically, a bandwidth of an NIC (Network Interface Card) that one load balancer device includes is typically up to about 10 Gbps. A bandwidth of the NIC that one cache server device includes is typically about 1 Gbps. That is, the cache servers that one load balancer device can manage is up to about ten sets. In this case, there is a third problem that the facility costs increase if one load balancer device is installed for the plurality of cache servers.

Furthermore, in the device described in Patent Literature 3, the device automatically selecting a proxy server optimal for a client, no consideration is provided about a fault-handling measure when a fault has arisen at the cache server itself that functions as the proxy server.

Therefore, based on the above problems, the main subject of the present invention is providing an automatic-fault-handling cache system and a handling method that do not increase the facility costs and operating costs as handling measures for a fault arising at the cache server even when a large number of cache servers are present on the network.

### Means of Solving the Problems

A typical example of the present invention will be described below. An automatic-fault-handling cache system comprises, on a network: one cache manager; a plurality of cache servers; cache agents operating on the cache servers, respectively; a database; and at least one PBR routers. The database comprises: a first database comprising identification information and a serial number of each of the cache agents; and a second database comprising identification information on each of the PBR routers and identification information on each of the cache servers that is close in terms of distance to each of the PBR routers. One of the cache agents comprises functionality of, with a trigger being detection of a fault at a first cache server, sending a notification of fault detection describing detection of the fault at the first cache server and identification information on the first cache server at which the fault has arisen to the cache manager. The cache manager comprises: functionality of acquiring, from the database, identification information on a first PBR router in which the identification information on the first cache server at which the fault is detected is registered as each of the cache servers close in terms of distance; functionality of acquiring, from the database, identification information on a second cache server registered as each of the cache servers close in terms of distance to the first PBR router; and functionality of accessing the first PBR router and altering a traffic forwarding destination of the first PBR router to the second cache server.

### Effects of the Invention

The present invention allows the backup cache servers to be altered to optimal servers dynamically, even when a large number of cache servers are present on the network. Therefore, even when a fault has arisen at one cache server on the network, the present invention allows end users to continue to use other cache servers, guarantees an SLA with respect to the end users, and can contribute to reduction in the facility costs and operating costs incurred by cache system managers.

### BRIEF DESCRIPTION OF DRAWINGS

FIG. 1 is a diagram illustrating the overall configuration of an automatic-fault-handling cache system according to embodiment 1 of the present invention.

FIG. 2A is a diagram illustrating the configuration of a cache manager of embodiment 1.

FIG. 2B is a diagram illustrating the configuration of a cache server of embodiment 1.

FIG. 3A is a diagram illustrating an example of the configuration of a nearby cache table in embodiment 1.

FIG. 3B is a diagram illustrating an example of the configuration of a cache server table in embodiment 1.

FIG. 3C is a diagram illustrating an example of rule setting content in embodiment 1.

FIG. 3D is a diagram illustrating an example of rule settings in embodiment 1.

FIG. 4 is sequence of cache server addition processing of embodiment 1.

FIG. 5 is a flow chart of nearby cache table update processing by the cache manager of embodiment 1.

FIG. 6A is a flow chart of cache server table update processing by the cache manager of embodiment 1.

FIG. 6B is a flow chart of rule setting processing of embodiment 1.

FIG. 7 is a flow chart of the cache manager of cache server addition processing of embodiment 1.

FIG. 8 is a diagram illustrating a handling method at the time of cache server fault in embodiment 1.

FIG. 9 is sequence at the time of cache server fault detection of embodiment 1.

FIG. 10 is a flow chart of cache server fault detection by the cache manager of embodiment 1.

FIG. 11 is a flow chart of cache server fault detection by the cache agent of embodiment 1.

FIG. 12 is sequence at the time of cache server recovery of embodiment 1.

FIG. 13 is a flow chart of cache server recovery by the cache manager of embodiment 1.

FIG. 14A is a flow chart of cache server addition request processing by the cache agent of embodiment 1.

FIG. 14B is a flow chart of distance measurement of embodiment 1.

FIG. 15 is a diagram of an example of distance measurement from a ping result of embodiment 1.

FIG. 16 is sequence of cache server deletion processing of embodiment 1.

FIG. 17 is a flow chart of the cache manager in cache server deletion processing of embodiment 1.

FIG. 18 is sequence of rule update processing of embodiment 1.

FIG. 19 is a flow chart of the cache manager in rule update processing of embodiment 1.

FIG. 20 is a flow chart of the cache agent in network configuration change detection processing of embodiment 1.

FIG. 21 is an overall flow chart of the cache manager of embodiment 1.

FIG. 22 is an overall flow chart of the cache agent of embodiment 1.

FIG. 23A is a diagram illustrating the configuration of a cache manager according to embodiment 2 of the present invention.

FIG. 23B is a diagram illustrating the configuration of a cache server according to embodiment 2.

FIG. 24 is the configuration of a cache server table of embodiment 2.

FIG. 25 is sequence at the time of cache server fault detection of embodiment 2.

FIG. 26 is a flow chart of overall operation of the cache manager of embodiment 2.

FIG. 27 is a flow chart of overall operation of the cache agent of embodiment 2.

### MODE FOR CARRYING OUT THE INVENTION

In the present invention, as a solution to the problems of the above-described conventional techniques, a traffic forwarding destination of a PBR router, which is forwarding traffic to a cache server at which a fault has arisen, is automatically altered when the fault arises at the cache server. Specifically, when the fault arises at the cache server, the traffic forwarding destination of the PBR router is altered to another cache server (hereinafter referred to as a backup cache server) that substitutes for the cache server at which the fault has arisen. It is assumed here that the backup cache server is a cache server close (for example, RTT is small) to the PBR router that is forwarding traffic to the cache server at which the fault has arisen. In the present invention, traffic forwarding destination alteration processing of the PBR router is processed by installing two types of devices (or modules) on the network and by causing the two types of devices to cooperate with each other. In the present invention, these two types of devices (or modules) are called a cache agent and a cache manager, respectively. Note that identification information on the backup cache server for each PBR router, that is, identification information on the cache server close in terms of distance to each PBR router is previously registered in a database included in the cache manager as a nearby cache table. An outline of traffic forwarding destination alteration processing of the PBR router is as follows. First, when a fault is detected at a cache server on which the cache agent itself performs fault monitoring, the cache agent notifies the cache manager of having detected the fault, and subsequently stops the cache server. On receipt of the notification, the cache manager refers to the database (nearby cache table) in which the identification information on the backup cache server has been registered, and acquires, from the database, identification information on the PBR router that is forwarding traffic to the cache server at which the fault has arisen, and identification information on the backup cache server for the PBR router. Furthermore, the cache manager accesses the PBR router that includes the acquired identification information, and alters the traffic forwarding destination to the backup cache server.

As described above, the present invention can solve the above-described problems without preparing the backup cache server for the cache server in advance, by dynamically managing a relationship between the cache server and its backup cache server by using the database, by extracting, from the database, the cache server close in terms of distance to the PBR router that is forwarding traffic to the cache server at which the fault has arisen, and by using the cache server as a backup cache server.

Note that, while the following embodiments will be described as fault-handling processing of the cache server, the fault-handling processing according to the present invention is not limited to processing when a fault arises in a cache server, and can be applied to processing when a cache server is suspended in connection with periodic maintenance of the cache server, and when network configuration change is detected.

Embodiments of the present invention will be described below with reference to the drawings.

### Embodiment 1

An automatic-fault-handling cache system according to embodiment 1 of the present invention will be described.

Here, an automatic-fault-handling cache system will be described for automating processing for altering a traffic forwarding destination of a PBR router to a backup cache server when a cache server fault has arisen. The present embodiment is an example in a case where a cache agent operates on a cache server device.

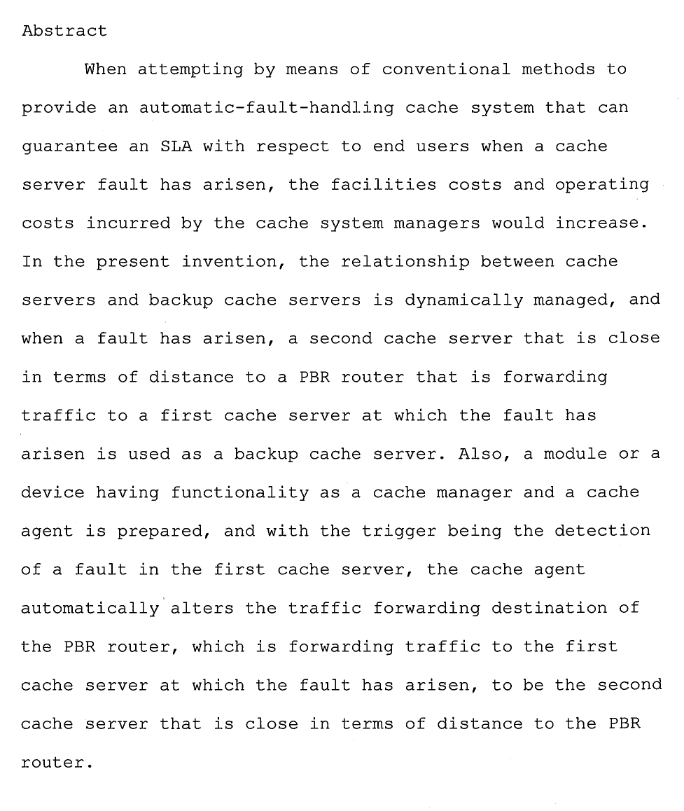

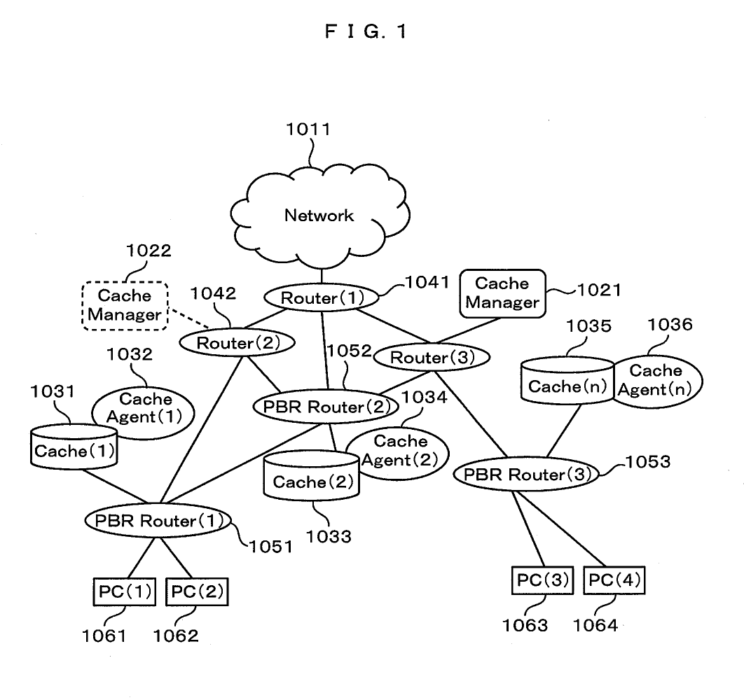

FIG. 1 illustrates the overall configuration example of a network on which the automatic-fault-handling cache system according to the present embodiment operates.

The network (1011) is a network, such as ISP (Internet Service Provider) and a carrier network, to which a server device (a Web server, a content server, etc.) (not illustrated) that provides service of content, etc. is connected. A cache manager (1021) is a main component (or a device) of the cache system of the present embodiment. Each of cache servers (1031, 1033, 1035) is a component (or a device) for holding a duplicate of content that the server device holds and provides to respective PCs (1061 to 1064), and for returning the content to respective client terminals (such as PCs) which are end users. On each of the cache servers (1031, 1033, 1035), modules that have functionality of cache agents (1032, 1034, 1036) operate, respectively. Each of the cache agents (1032, 1034, 1036) is a component that constitutes the cache system of the present embodiment, and operates in cooperation with the cache manager (1021).

In the present embodiment, the network is constituted by at least one cache manager (1021), a plurality of routers (1041 to 1043), and a plurality of PBR (Policy Based Routing) routers (1051 to 1053).

Here, the PBR router refers to a router device having functionality of performing routing based on a rule that describes conditions of forwarding traffic and traffic forwarding destinations. In addition, any network using a repeater device equivalent to the router and the PBR router can constitute a cache system similar to the cache system of the present embodiment.

Note that in the present invention, RTT (Round Trip Time, round trip delay time) is used as an indicator for measuring a distance on the network. Under the Internet protocol, RTT can be measured by ICMP (Internet Control Message Protocol). In addition, the present invention can be applied to other protocols if such protocols have means for measuring RTT. If there is an indicator that can be used as a distance between the PBR router and the cache server other than RTT, such as a physical distance, a hop number, and a one-way RTT value instead of a round trip RTT, such an indicator can substitute for RTT.

A cache manager (1022) may be provided on the network (1011) as a backup manager that substitutes and operates for the cache manager (1021) when the cache manager (1021) fails.

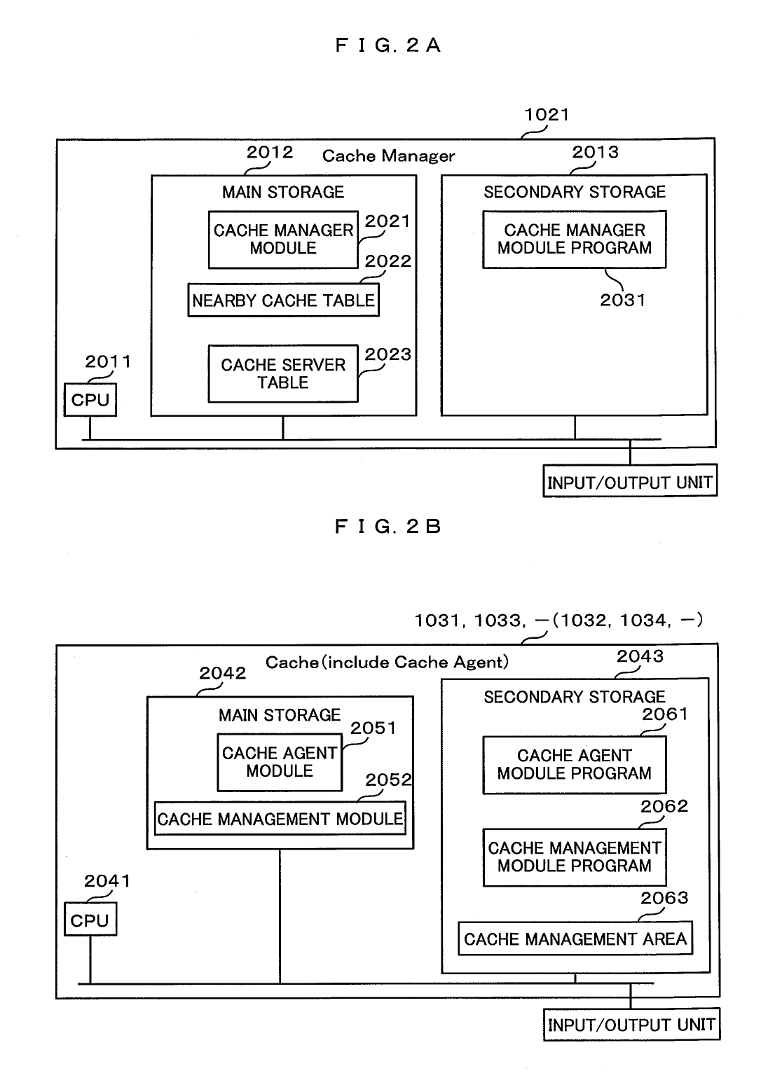

FIG. 2A and FIG. 2B illustrate the detailed configurations of the cache manager (1021) and each of the cache servers (1031, 1033) of FIG. 1, respectively.

First, as illustrated in FIG. 2A, the cache manager (1021) includes a CPU (2011), a main storage (2012), and a secondary storage (2013). The main storage (2012) includes a cache manager module (2021), a nearby cache table (2022), and a cache server table (2023). The cache manager module (2021) is a run-time image of a program for controlling the cache manager (1021). Detailed operation of the cache manager module (2021) will be described later. The nearby cache table (2022) is a table that holds a plurality of identification information items on the cache servers, each of the cache servers being close in terms of distance to each PBR router on the network, that is, backup cache servers. Here, the cache servers close in terms of distance to each PBR router are registered in a sequential order as a first nearby cache server, a second nearby cache server, and a third nearby cache server.

The secondary storage (2013) includes a cache manager module program (2031). During cache manager (1021) operation, the cache manager module program (2031) is developed on the main storage (2012) and is executed as the cache manager module (2021).

Next, as illustrated in FIG. 2B, each of the cache servers (1031, 1033) includes a CPU (2041), a main storage (2042), and a secondary storage (2043). The main storage (2042) includes a cache agent module (2051) and a cache management module (2052). The cache agent module (2051) is a run-time image of a program for controlling each of the cache agents (1032, 1034). Detailed operation of the cache agent module (2051) will be described later. The cache management module (2052) is a run-time image of a program for caching and distributing content. The secondary storage (2043) includes a cache agent module program (2061), a cache management module program (2062), and a cache management area (2063). During each cache agent (1032, 1034) operation, the cache agent module program (2061) is developed on the main storage (2042), and is executed as the cache agent module (2051). During cache server (1031, 1033) operation, the cache management module program (2062) is developed on the main storage (2042), and is executed as the cache management module (2052). In the present embodiment, a general-purpose program is used as the cache management module program (2062). The cache management area (2063) is an area that the cache management module (2052) manages, and is an area in which content is cached.

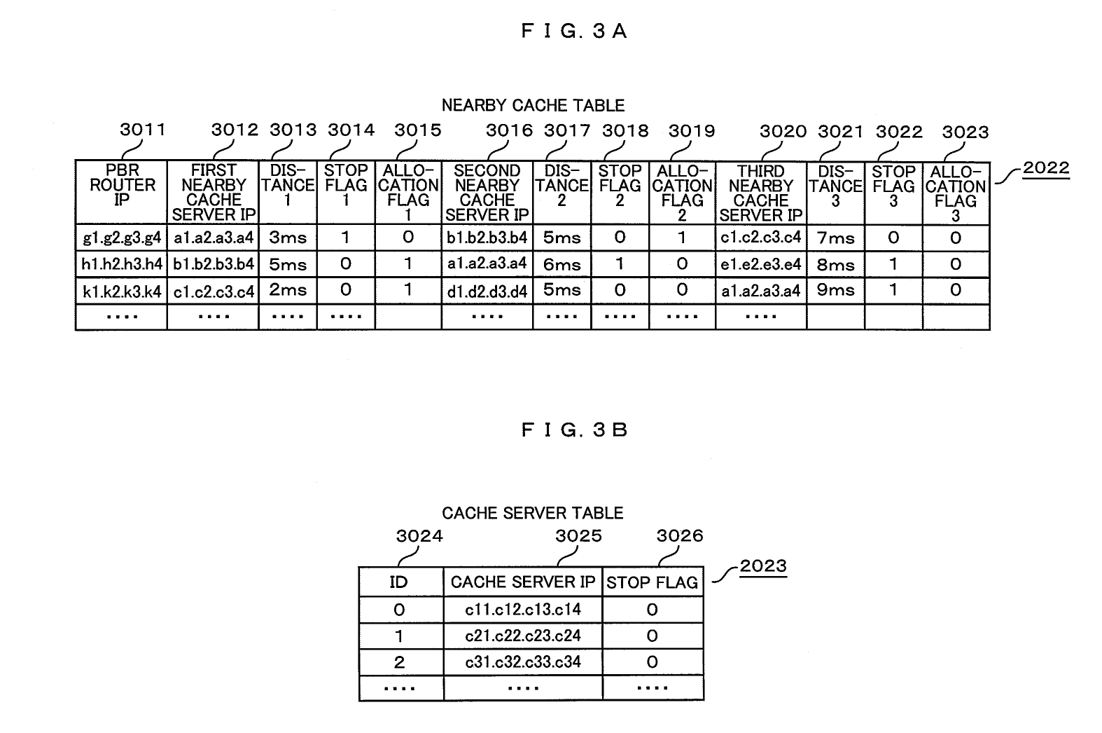

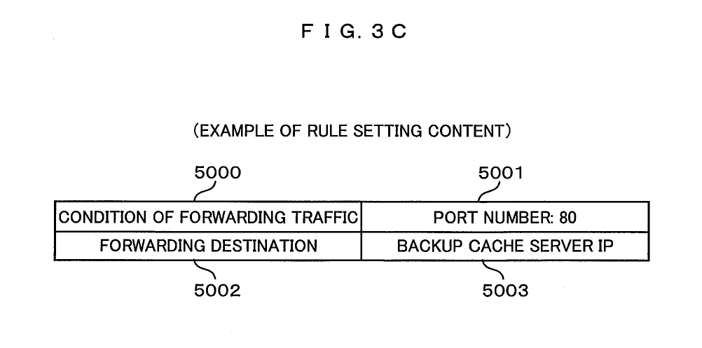

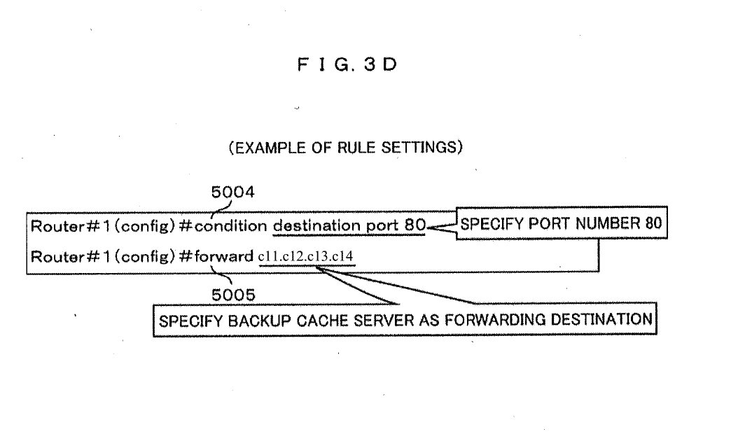

FIG. 3A illustrates details of the nearby cache table (2022). The nearby cache table (2022) includes a PBR router IP address column (3011) that identifies the PBR router on the network, a first nearby cache server IP column (3012) that holds the IP address of the first nearby cache server, a second nearby cache server IP column (3016) that holds the IP address of the second nearby cache server, a third nearby cache server IP column (3020) that holds the IP address of the third nearby cache server, and a distance 1 column (3013), a distance 2 column (3017), a distance 3 column (3021) that represent distances from the PBR router to the first nearby cache server, the second nearby cache server, and the third nearby cache server, respectively. In addition, the nearby cache table (2022) includes stop flag columns (3014, 3018, 3022) that represent whether each cache server has stopped, and allocation flag columns (3015, 3019, 3023) that represent whether each cache server has been allocated as the traffic forwarding destination of the PBR router. Here, when the cache server has stopped, the stop flag is set to 1 as on, and when the cache server has not stopped, the stop flag is set to 0 as off. Similarly, when the cache server has been allocated as the traffic forwarding destination for the PBR router, the allocation flag is set to 1 as on, and when the cache server has not been allocated as the traffic forwarding destination for the PBR router, the allocation flag is set to 0 as off. Although it is assumed here that the number of registered cache servers is three, any number of cache servers may be registered if the number is one or more. Here, the IP address for identifying the PBR router is unique to the PBR router device.

Note that a primary key of the nearby cache table (2022) is the PBR router IP address column (3011), and one specific line can be determined by using the PBR router IP address column.

The first to third nearby cache servers are set for each PBR router in the nearby cache table in increasing order of distance from each PBR router. These distance relationships always change depending on the presence of failure in the cache servers, addition and deletion of the cache servers, or communication environments. That is, the cache manager (1021) performs following fault-handling processing of the cache servers, cache server recovery-handling processing, cache server addition processing, cache server deletion processing, and rule update processing. During the process, the cache manager (1021) automatically updates the nearby cache table (2022) and the cache server table (2023). Accordingly, the configuration of the first to third nearby cache servers with respect to each PBR router in the nearby cache table changes dynamically.

For example, it is assumed that g1.g2.g3.g4 in the PBR router IP address column (3011) on the first line of the list in the nearby cache table refers to the PBR router (1051) of FIG. 1, and that the first nearby cache server (1031), the second nearby cache server (1033), and the third nearby cache server (1035) are registered in increasing order of distance with respect to the PBR router (1051). When a fault has arisen at the first nearby cache server (1031), the stop flag 1 of the first nearby cache server (1031) is set to on (1), a backup cache server of which the distance from the PBR router (1051) is the smallest and the stop flag is off (0) other than the first nearby cache server (1031), that is the second nearby cache server (1033) here is set to a new first nearby cache server, its allocation flag 2 is set to on (1), and the second nearby cache server (1033) is altered to the traffic forwarding destination for the PBR router (1051).

In addition, regarding the PBR router on each line of the nearby cache table, columns for registering a CPU usage rate, a load, priority, and the like of each cache server may be added to each cache server IP column (3012, 3016, 3020). This will be described in detail later.

The cache server table (2023) is a list of the cache servers that exist on the network.

FIG. 3B illustrates the cache server table (2023). The cache server table (2023) includes an ID column (3024) that is serial numbers, a cache server IP address column (3025) that identifies the cache servers, and a stop flag column (3026) that represents whether each cache server has stopped. Here, the IP address for identifying the cache server is unique to the cache server device. The stop flags are identical to the stop flags (3014, 3018, 3022) in the nearby cache table (2022). The primary key of the cache server table (2023) is the ID column (3024), and one specific line can be determined by using the ID column. The cache server IP address column (3025) is also a unique column, and one specific line can be determined by using the cache server IP address column.

Here, the traffic forwarding destination and forwarding traffic condition of the PBR router are together called “a rule”. As illustrated in FIG. 3C, the rule includes specification fields for a condition of forwarding traffic 5000 of the PBR router, a port number 5001, a traffic forwarding destination 5002, and a cache server 5003. In an example of settings of FIG. 3D, a condition of forwarding traffic 5004 is specified as a destination port 80 with jyouken (condition) destination port 80. In addition, c11.c12.c13.c14 is specified as a traffic forwarding destination 5005 that satisfies the condition of forwarding traffic with tensou (forward) c11.c12.c13.c14. Note that appropriate commands determined by the PBR router to be used are used for setting the rule.

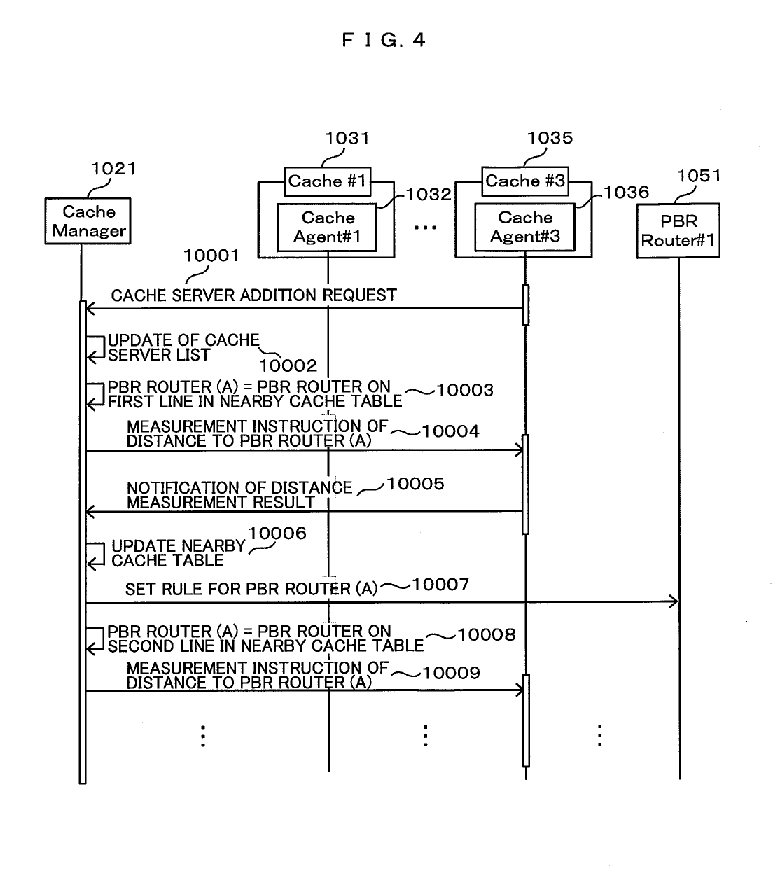

FIG. 4 illustrates sequence of cache server addition processing for adding a new cache server to the present system. For example, in the embodiment of FIG. 1, it is assumed to add the new cache server (1035) to the existing system in which the cache servers (1031, 1033) exist. Note that similar processing is also performed when newly creating an automatic-fault-handling cache system automatically or initializing and resetting data of the existing system.

This processing is performed between the cache manager (1021) and the cache agent (1036) of the cache server to be newly added (1035). First, the cache agent (1036) that operates on the cache server (1035) to be newly added sends a cache server addition request (10001) to the cache manager (1021). Subsequently, the cache manager (1021) adds a record regarding the newly added cache server (1035) to the cache server table (2023), and updates the cache server table (10002).

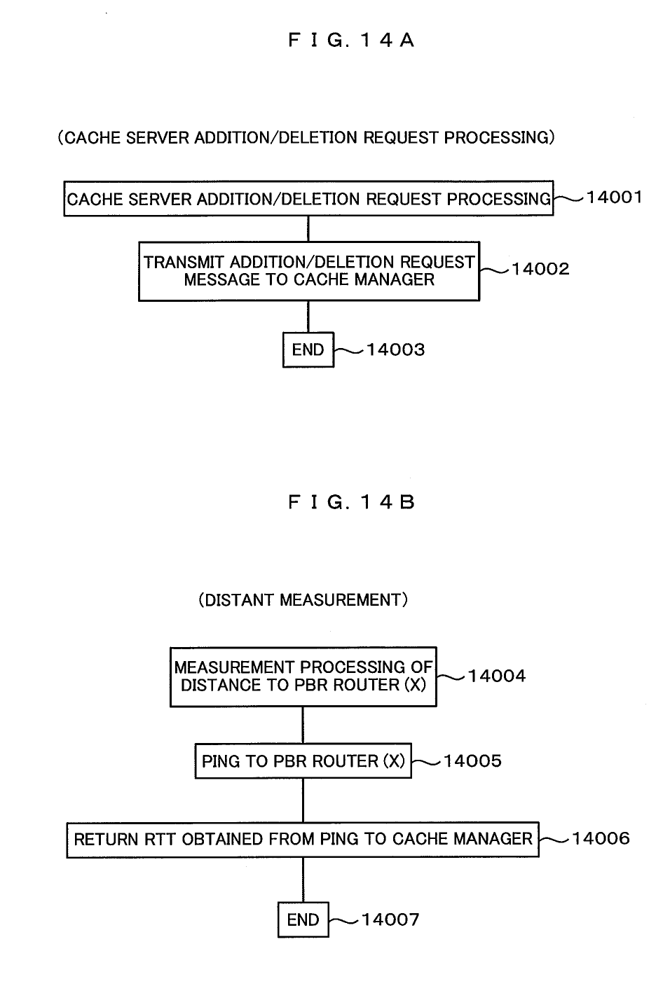

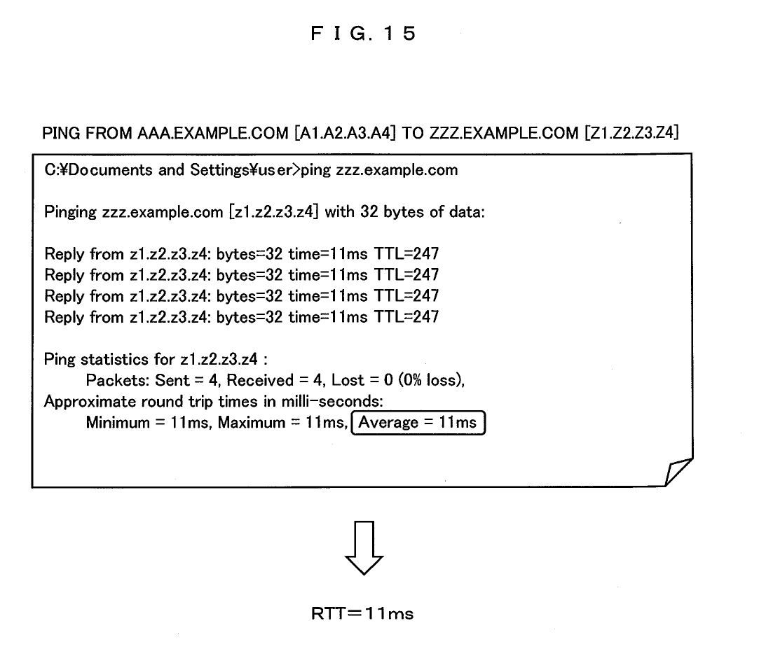

Subsequently, the cache manager (1021) extracts all the PBR router IPs from the PBR router IP column (3011) in the nearby cache table (2022) and makes a list, sets the PBR router on the first line of the list as the PBR router “A” (10003), and sends the cache agent (1036) a measurement instruction of distance to the PBR router “A” (10004). The cache agent (1036) notifies the cache manager (1021) of a distance measurement result (10005). (See FIG. 14B and FIG. 15 for processing of distance measurement).

Subsequently, the cache manager (1021) totals the distance measurement result returned from the cache agent (1036), and adds a cache server having a small distance to the nearby cache table (2022), and updates the nearby cache table (2022) (10006). Subsequently, the cache manager (1021) accesses the PBR router (1051), and sets the rule (the condition of forwarding traffic, and the traffic forwarding destination) via a command line (10007). After rule setting for the PBR router “A” is completed, the cache manager (1021) extracts the PBR router on the second line of the list, sets the PBR router as the PBR router “A” (10008), and sends the cache agent (1036) a measurement instruction of distance to the PBR router “A” (10009). After this, the above processing is continued on a remaining part of the list.

As described above, with the trigger being the startup of the cache agent (1032, 1034), the present system performs automatic processing for setting the condition of forwarding traffic and the traffic forwarding destination for each PBR router. Note that in order for each cache agent (1032, 1034) to send an addition request to the cache manager (1021) after the startup, each cache agent (1032, 1034) needs to hold identification information such as the IP address of the cache manager (1021). It is assumed here that each cache agent (1032, 1034) holds the identification information, such as the IP address of the cache manager (1021), at the time of startup, and thus the above-described automatic processing is triggered by the startup of the cache agent (1032, 1034).

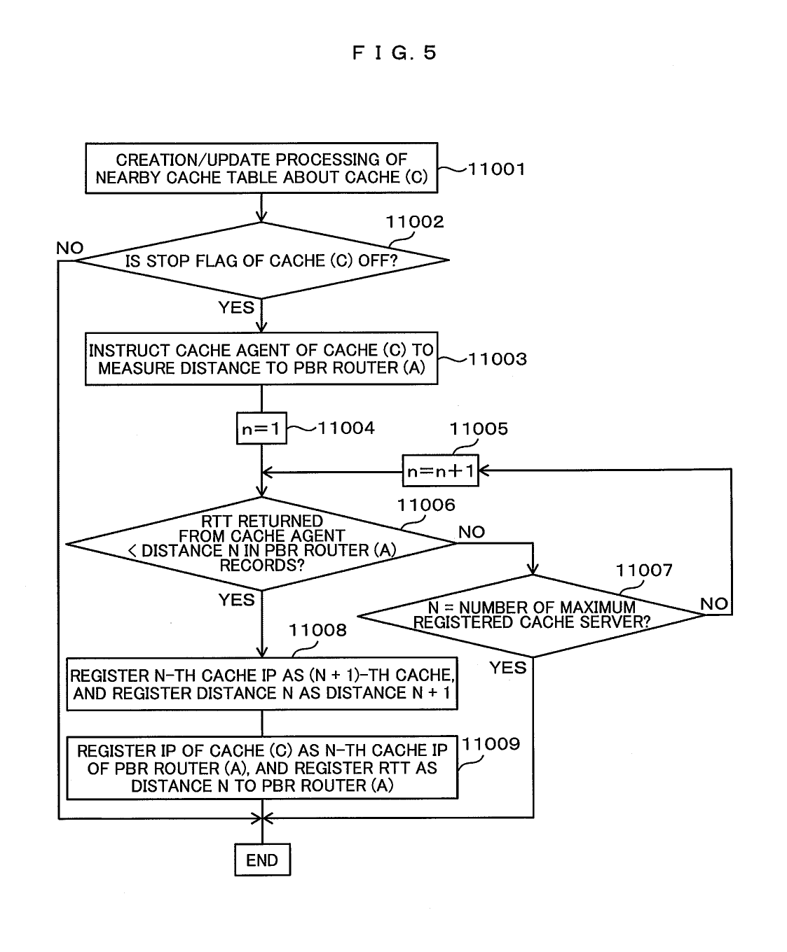

FIG. 5 illustrates a flow chart of update processing of the nearby cache table (2022) in the processing for adding the cache server C of FIG. 4 (10006). After the start of the update processing of the nearby cache table regarding the cache server C to be added (11001), the cache manager (1021) determines from the cache server table whether the stop flag of the cache server C is off or not (11002). Subsequently, the cache manager (1021) instructs the cache agent (1032, 1034) that operates on the cache server C to measure the distance to the PBR router “A” (11003). Subsequently, the variable n is set to 1 (11004). Subsequently, the cache manager (1021) receives a distance measurement result from the cache agent (1032, 1034), and determines whether the result is smaller than a value registered as the distance n in the PBR router “A” records of the nearby cache table (2022) (11006). When the result is large, the cache manager (1021) determines whether the value of the variable n matches the number of maximum registered cache servers (11007). When the value of the variable n does not match the number of maximum registered cache servers, the cache manager (1021) adds 1 to the value of the variable n (11005), and returns to the processing 11006. While, when the value of the variable n is large, the cache manager (1021) ends processing. When the distance measurement result is smaller than the distance n in the PBR router “A” records, the cache manager (1021) registers the n-th cache server IP as the (n+1)-th cache server IP, and registers the distance n as the distance n+1 (11008). Subsequently, the cache manager (1021) registers the IP address of the cache server C as the n-th cache server IP of the PBR router “A” records in the nearby cache table (2022), and registers the received distance measurement result as the distance n (11009). Subsequently, the cache manager (1021) ends processing.

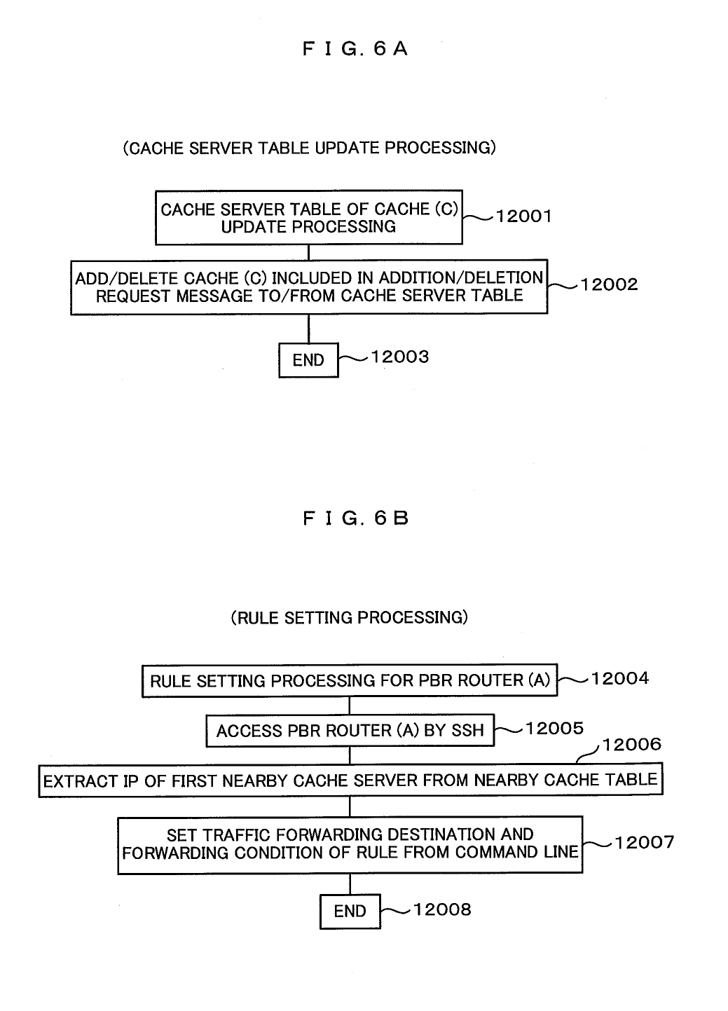

FIG. 6A and FIG. 6B illustrate flow charts of cache server table update processing (10002) and rule setting processing (10007), respectively, in the cache server addition processing of FIG. 4.

FIG. 6A is a flow chart of update processing of the cache server table (2023). After the start of cache server table update processing of the cache server C (12001), the cache manager (1021) adds the IP address of the cache server C included in an addition request message sent from each cache agent (1032, 1034) to the cache server table (2023) (12002), and ends processing (12003). When a deletion request message is sent from the cache agent (1032, 1034), the cache manager (1021) deletes the IP address of the cache server C from the cache server table (2023) (12002), and ends processing (12003).

FIG. 6B is a flow chart of rule setting processing. After the start of rule setting processing for the PBR router “A” (12004), the cache manager (1021) accesses the PBR router “A” with an ssh command or the like (12005). Although the ssh command is used here to access the PBR router, any command or means that has similar functionality can substitute for the ssh command. Subsequently, the cache manager (1021) extracts the IP address of the first nearby cache server registered in the PBR router “A” records from the nearby cache table (2022) (12006). Subsequently, the cache manager (1021) sets the extracted IP address as the forwarding destination from the command line, and sets the forwarding condition similarly (12007). Subsequently, the cache manager (1021) ends processing (12008).

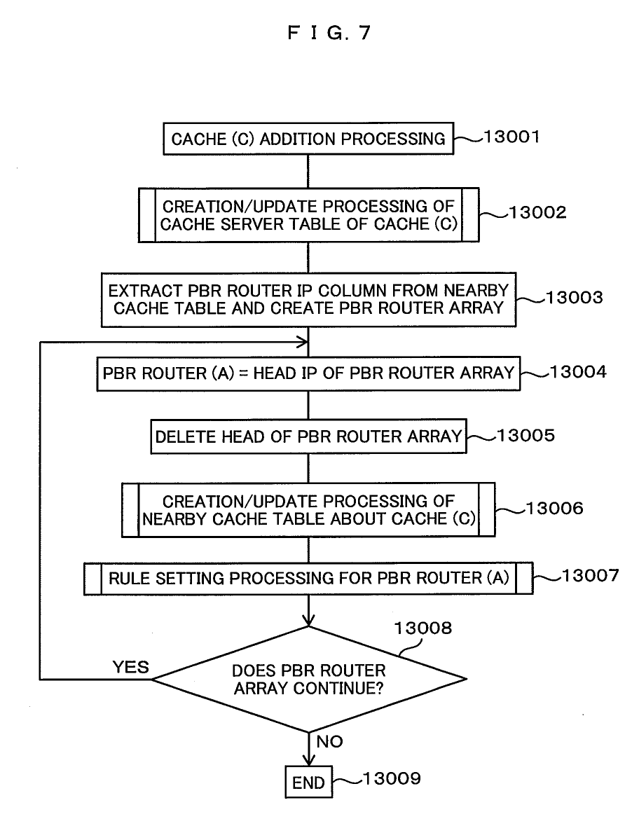

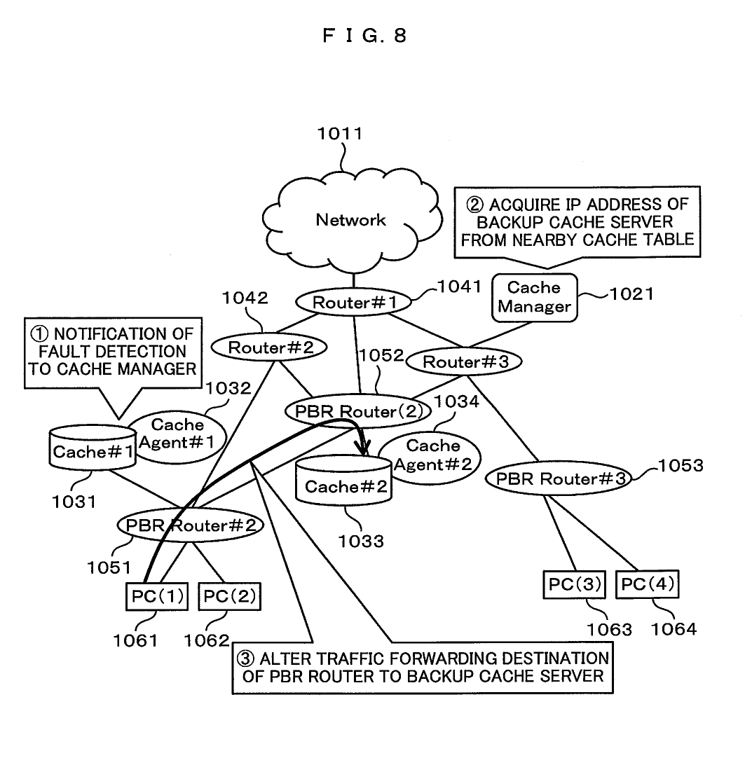

FIG. 7 illustrates a flow chart of a processing part by the cache manager (1021) in the cache server addition processing of FIG. 4. After the start of cache server C addition processing (13001), the cache manager (1021) performs update processing of the cache server table of the cache server C of FIG. 6A (13002). Subsequently, the cache manager (1021) extracts the PBR router IP address column (2041) of all the records from the nearby cache table (2022), and creates a PBR router array (13003). Subsequently, the cache manager (1021) copies a head of the PBR router array to the variable PBR router “A” (13004), and deletes the head of the PBR router array (13005). Subsequently, the cache manager (1021) performs nearby cache table update processing about the cache server C of FIG. 5 (13006). Subsequently, the cache manager (1021) performs rule setting processing for the PBR router “A” of FIG. 6B (13007), and determines whether the PBR router array continues (13008). When the PBR router array continues, the cache manager (1021) returns to the procedure 13004. When the PBR router array does not continue, the cache manager (1021) ends processing here (13009).

Subsequently, an overall operation of the automatic-fault-handling cache system according to the present embodiment will be described. The following describes processing performed when a cache agent detects a fault in a cache server and processing performed when a cache agent detects a cache server that has recovered from a fault in the present system.

That is, the following description assumes cases where the cache agent (1032) detects a fault at the first cache server (1031), and where subsequently the first cache server (1031) has recovered, as illustrated in FIG. 8. The cache agent (1032) that operates on the cache server (1031) at which the fault has arisen notifies the cache manager (1021) of “fault detection.” In response to this notification, the cache manager (1021) stops the first cache server (1031) at which the fault has arisen. Regarding the PBR router (1051) on the first line of the list in the nearby cache table, with reference to the nearby cache table 2022, the cache manager (1021) acquires the IP address of the second cache server of which the stop flag is off and the distance is the smallest other than the first cache server (1031) at which the fault has arisen, as the backup cache server. Then, the cache manager (1021) alters the traffic forwarding destination of the PBR router (1051) to the specified second cache server (1033). After the completion of alteration of the forwarding destination of the PBR router on the first line in the list, regarding the PBR router (1052) on the second line in the list of the nearby cache table, the cache manager (1021) performs processing of alteration of the traffic forwarding destination, and alters the forwarding destination to the specified backup cache server. Similarly, the cache manager (1021) performs alteration processing of the forwarding destination of the PBR router on each line in the nearby cache table. The following describes the details.

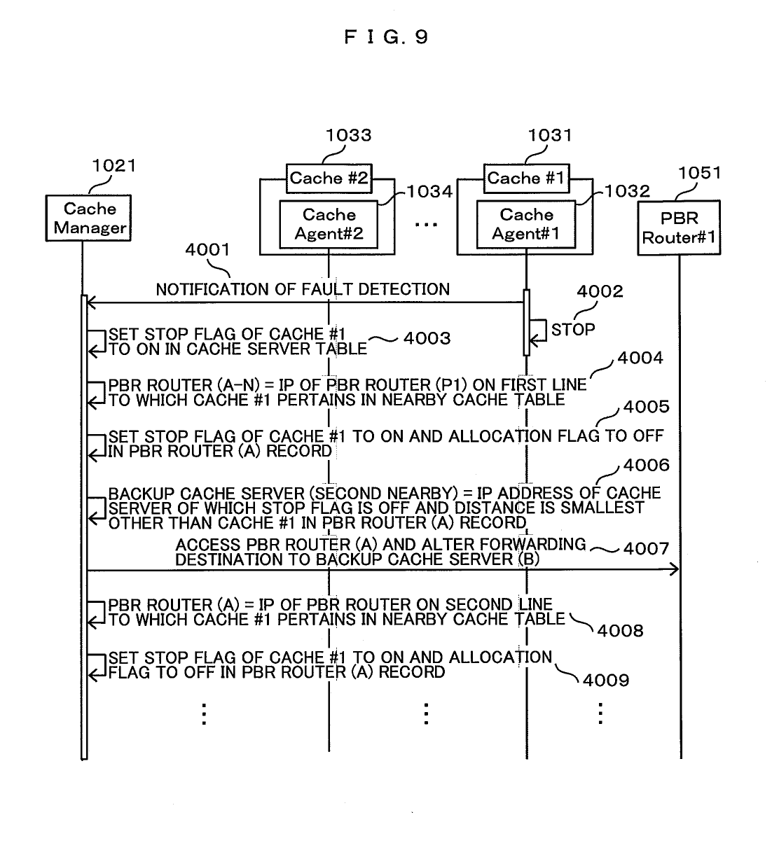

FIG. 9 illustrates cache server fault-handling processing sequence when the cache agent (1032) detects a fault at the first cache server (1031) in the present system. This processing is performed between the cache agent (1032) that operates on the cache server at which the fault has arisen and the cache manager (1021). First, the cache agent (1032) that operates on the first cache server (1031) at which the fault has arisen sends a notification of fault detection to the cache manager (1021) (4001), and stops the first cache server (1031) (4002). Subsequently, the cache manager (1021) sets the stop flag (3026) in the record of the first cache server (1031) at which the fault has arisen to on in the cache server table (2023) (4003).

Subsequently, the cache manager (1021) extracts the plurality of PBR router IPs to which the first cache server (1031) at which the fault has arisen pertains and makes a list, out of the PBR router IP column (3011) in the nearby cache table (2022), and sets the PBR router (1051) on the first line in this list as the PBR router “A” (4004). Next, the cache manager (1021) sets the stop flag (3014) of the first cache server (1031) at which the fault has arisen to on in the PBR router “A” record, and sets the allocation flag (3015) to off (4005). Furthermore, the cache manager (1021) extracts, from the nearby cache table (2022), the second cache server IP of which the distance is the smallest and the stop flag is off other than the first cache server (1031) at which the fault has arisen in the PBR router “A” record, and sets the second cache server IP as the backup cache server B (4006). Finally, the cache manager (1021) accesses the PBR router “A” (1051), and alters the traffic forwarding destination to the backup cache server B (the second cache server 1033) via the command line (4007). Although only the traffic forwarding destination is altered here, it is assumed that not only the traffic forwarding destination but also the condition of forwarding traffic are set in the PBR router in advance (see FIG. 3C and FIG. 3D).

After the completion of alteration of the forwarding destination of the PBR router “A” (1051), the cache manager (1021) extracts the PBR router (1052) on the second line in the list of the PBR router IP column (3011), and sets the PBR router (1052) as the PBR router “A” (4008). The cache manager (1021) sets the stop flag of the first cache server (1031) at which the fault has arisen to on in the PBR router “A” record, and sets the allocation flag to off (4009). Furthermore, the cache manager (1021) extracts, from the nearby cache table (2022), a cache server IP of which the stop flag is off and the distance is small other than the first cache server (1031) at which the fault has arisen in the PBR router “A” record on the second line, and sets the cache server IP as the backup cache server B. The cache manager (1021) also extracts the PBR router (1053) on the third line in the list of the PBR router IP column (3011) similarly, sets the PBR router (1053) as the PBR router “A”, and continues the above processing hereinafter.

As described above, in the present system, with the trigger being fault detection at the cache server (1031, 1033, - - - ) on which the cache agent (1032, 1034, - - - ) itself operates, the cache agent (1032, 1034, - - - ) automatically alters the traffic forwarding destination of each PBR router to another cache server that is close in terms of distance to the cache server at which the fault has arisen, that is, the backup cache server. Although the cache server that is close in terms of distance to the PBR router device, which is forwarding traffic to the cache server at which the fault has arisen, is used as the backup cache server here, it is also possible to register a CPU usage rate of each cache server and a priority flag of each cache server that a cache system manager sets in the nearby cache table that the cache manager holds, and to select the backup cache server by using the information in addition to the distance between each PBR router and the cache server. For example, out of the cache servers having the distance of 20 ms or less from the PBR router, the cache server with the lowest CPU usage rate may be used as the backup cache server. In this case, avoidance of the backup cache server becoming an overload and suppression of a fault incidence rate of the backup cache server are expected.

In addition, it is also considered that the cache system manager that installs the cache server devices sets the priority flag in consideration of the performance of respective cache servers, and selects the backup cache server based on the priority flag in addition to the distance to the PBR router device and the CPU usage rate of each cache server. Regarding the priority flag, it is considered to register a cache server that has a high-performance CPU and a large-capacity HDD or SDD as a high-performance cache server for the purpose of using the cache server as the backup cache server with priority over other cache servers. For example, it is considered to set the priority flag of the high-performance cache server to on, and to select a cache server having the smallest CPU usage rate and the smallest distance to the PBR router as the backup cache server, from among the cache servers of which the priority flag is on. It is assumed that the priority flag is included in the addition request message that the cache agent notifies to the cache manager at the time of addition of the cache server. As described above, when the priority flag is used as one of the selection criteria, the high-performance cache server can be used as the backup cache server with priority. The high-performance cache server, that is, the cache server having a high-performance CPU is expected to respond to an end user quickly. The cache server having a large-capacity HDD or SDD can hold a lot of content, and is expected to exhibit a high hit rate of the content that an end user requests.

Alternatively, it is also considered that, based on an access ranking to the server device from respective PCs on the network, in other words, a popularity ranking of service such as content, the cache manager grasps a caching situation of each server device in advance, and gives high priority to the cache server related to such a server device. This can increase an end user's hit rate of the cache.

In order for the cache agent (1032, 1034) to perform notification of fault detection to the cache manager (1021) after fault detection of the cache server, the cache agent (1032, 1034, - - - ) needs to hold identification information, such as the IP address, of the cache manager (1021). It is assumed here that the cache agent (1032, 1034) holds the identification information such as the IP address of the cache manager (1021) at the time of startup.

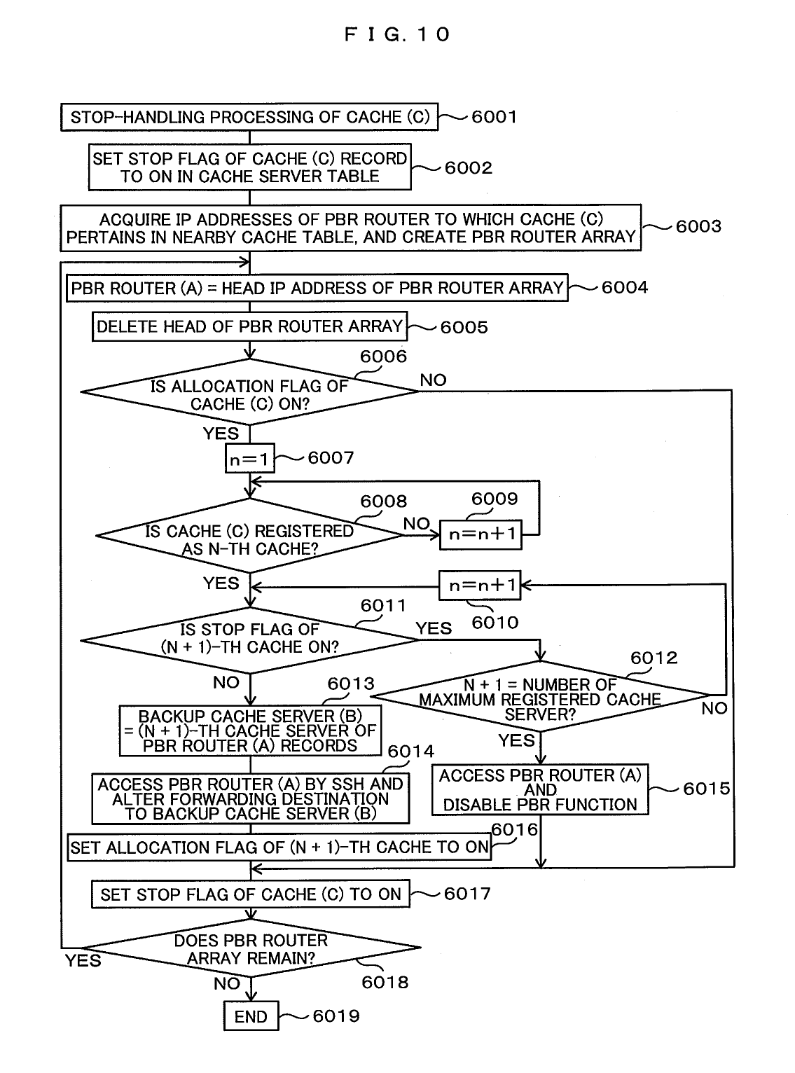

FIG. 10 illustrates a flow chart of the cache manager (1021) in the cache server fault-handling processing. After the start of fault-handling processing about the cache server C (for example, cache server 1031) at which a fault has arisen (6001), the cache manager (1021) sets the stop flag of the cache server at which the fault has arisen to on, the stop flag being registered in the cache server table (6002). Subsequently, the cache manager extracts the IP addresses of the plurality of PBR routers to which the cache server C at which the fault has arisen pertains in the nearby cache table, and creates the PBR router array (6003). Subsequently, the cache manager copies the head IP address of the PBR router array to the variable PBR router “A” (6004), and deletes the head of the PBR router array (6005). Subsequently, the cache manager determines whether the allocation flag of the cache server C at which the fault has arisen is on in the PBR router “A” record registered in the nearby cache table (2022) (6006). When the allocation flag is not on, the cache manager moves to the next processing 6017. When the allocation flag is on, the cache manager sets the variable n to 1 (6007), and determines whether the cache server C at which the fault has arisen has been registered as the n-th cache server (6008). When the cache server C at which the fault has arisen has not been registered, the cache manager adds 1 to the variable n (6009), and returns to the procedure 6008. When the cache server C at which the fault has arisen has been registered as the n-th cache server, the cache manager (1021) determines whether the stop flag of the (n+1)-th cache server is on (6011). When the stop flag is on, the cache manager determines whether n+1 is identical to the number of cache servers registered for each PBR router in the nearby cache table (2022) (6012).

In the case of the nearby cache table (2022) of FIG. 3A, the number of cache servers registered for each PBR router is three. When it is identical to the number, the cache manager accesses the PBR router “A” by the ssh (Secure Shell) command or the like, disables the PBR functionality (6015), and moves to the procedure 6017. Although the ssh command is used here to access the PBR router, any command or means having similar functionality can substitute for the ssh command. When n+1 is not identical to the number, the cache manager adds 1 to the variable n (6010), and returns to the procedure 6011. When the stop flag of the (n+1)-th cache server is not on, the cache manager substitutes the IP address of the (n+1)-th cache server in the PBR router “A” records for the variable backup cache server B (6013). Subsequently, the cache manager accesses the PBR router “A” by ssh and alters the traffic forwarding destination of the PBR router “A” to the backup cache server B (6014). Subsequently, the cache manager sets the allocation flag of the (n+1)-th cache server to on (6016), and sets the stop flag of the cache server C at which the fault has arisen to on (6017). Subsequently, the cache manager determines whether the PBR router array remains (6018). When the PBR router array remains, the cache manager returns to the procedure 6004. While, when the PBR router array does not remain, the cache manager ends processing (6019).

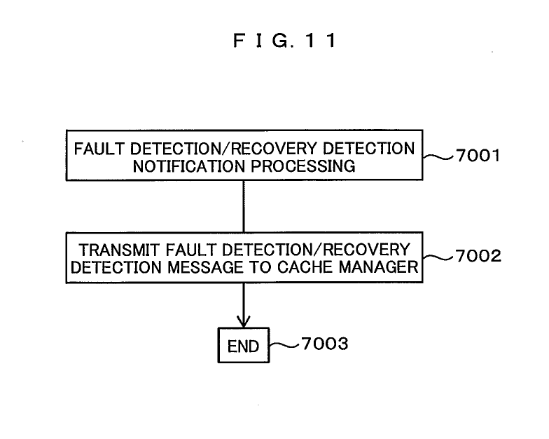

FIG. 11 illustrates a flow chart of notification processing of fault detection by each cache agent (1032, 1034) in the cache server fault-handling processing. After the start of fault detection notification processing (7001), the cache agent (1032, 1034) transmits a fault detection message to the cache manager (1021) (7002), and ends processing (7003). Here, the fault detection message has such a form that the cache manager (1021) can confirm that the message is a fault detection message from any one of the cache agent (1032, 1034) of the present system, and that the IP address of the cache server at which the fault has arisen is included within the message. If the message can inform the cache manager (1021) that the forwarding destination of the PBR router forwarding traffic to the cache server at which the fault has arisen will be altered, the fault detection message may have any form.

When the cache agent (1032, 1034) detects recovery of the cache server, the cache agent (1032, 1034) performs notification of cache server recovery detection to the cache manager (1021). Although the recovery detection message may have any form, the recovery detection message has such a form that the cache manager (1021) can confirm that the message is a recovery detection message from the cache agent (1032, 1034) of the present system, and that the IP address of the recovered cache server is included within the message.

The processing described so far allows the present system to perform fault-handling processing of the cache server at which the fault has arisen. The use of a cache server close in terms of distance to the cache server at which the fault has arisen as a backup cache server has an advantage of preventing degradation of response speed to a request from an end user.

Subsequently, processing performed in a case where the cache server that has stopped because a fault has arisen recovers to the present system will be described.

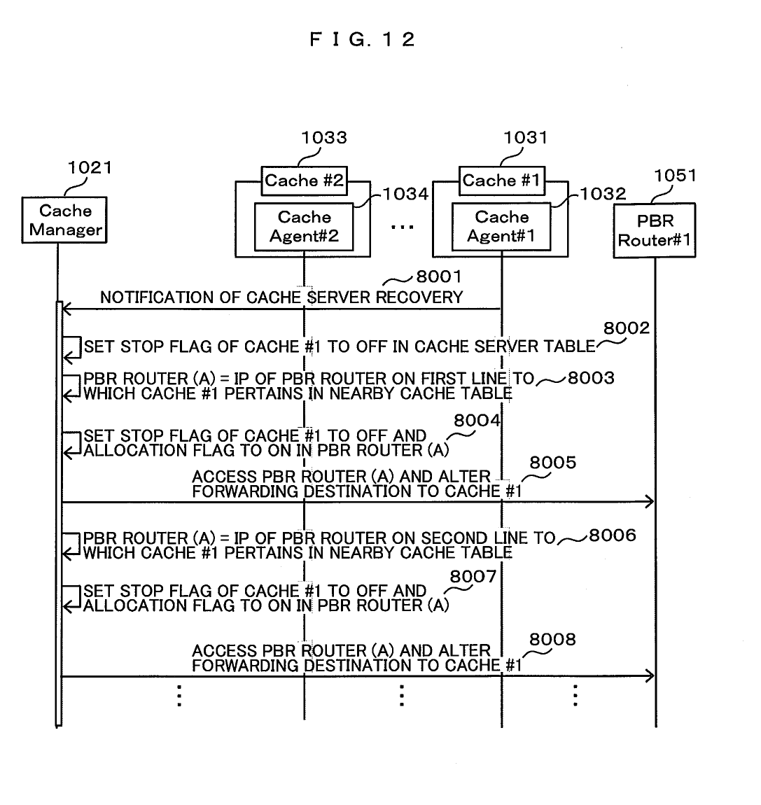

FIG. 12 illustrates sequence of processing in the case where the cache server that has stopped because the fault has arisen recovers to the present system. This processing is performed between the cache manager (1021) and the cache agent (1032) that operates on the cache server that has recovered (1031). First, the cache agent (1032) that operates on the cache server (1031) that has recovered sends a notification of cache server recovery (8001) to the cache manager (1021). Subsequently, the cache manager (1021) sets the stop flag of the cache server (1031) that has recovered to off in the cache server table (8002). Subsequently, the cache manager (1021) extracts the plurality of PBR router IPs to which the cache server (1031) that has recovered pertains from the PBR router IP column (3011) in the nearby cache table (2022), makes a list, and sets the PBR router on the first line in the list as the PBR router “A” (8003). Next, the cache manager (1021) sets the stop flag (3014, 3018, 3022) of the cache server (1031) that has recovered in the PBR router “A” record to off, and sets the allocation flag (3015, 3019, 3023) to on (8004). Furthermore, the cache manager (1021) accesses the PBR router “A”, and sets the traffic forwarding destination to the cache server that has recovered via a command line (8005). After the completion of alteration of the forwarding destination of the PBR router “A”, the cache manager (1021) extracts the PBR router on the second line of the list, and sets it as the PBR router “A” (8006). The cache manager (1021) sets the stop flag (3014, 3018, 3022) of the cache server (1031) that has recovered to on in the PBR router “A” record, and sets the allocation flag (3015, 3019, 3023) to off (8007). Furthermore, the cache manager (1021) accesses the PBR router “A”, and sets the traffic forwarding destination to the cache server that has recovered via a command line (8008). After this, the above processing is continued on a remaining part of the list.

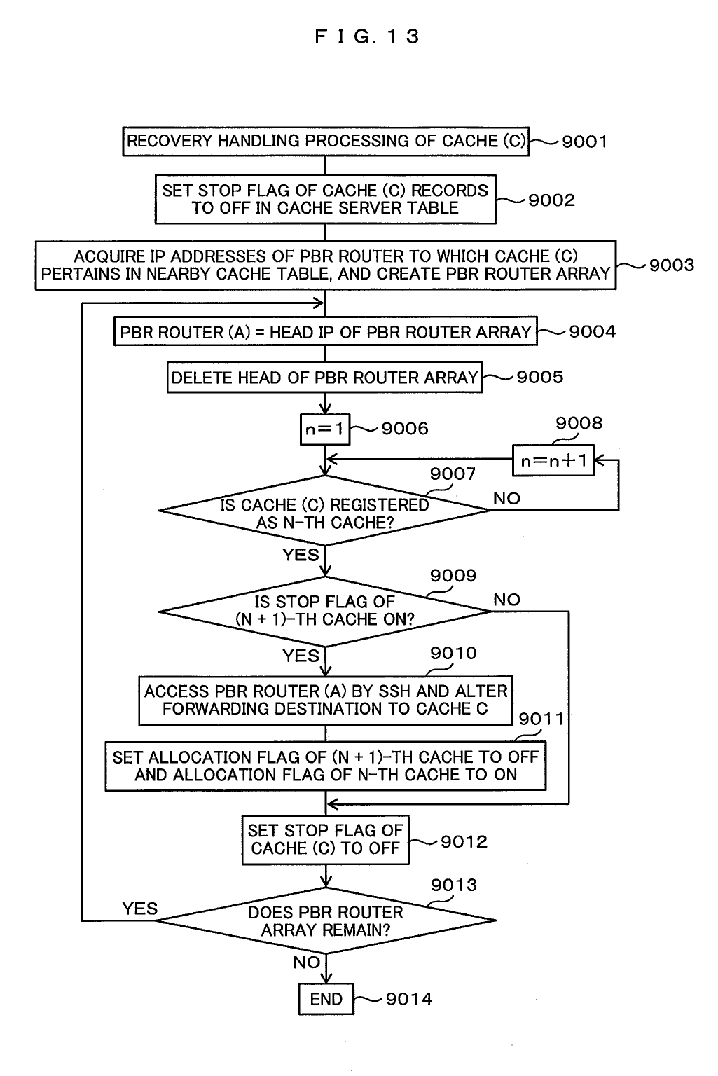

FIG. 13 illustrates a flow chart of processing by the cache manager (1021) in the cache server recovery handling processing. After the start of recovery handling processing about the cache server C (1031) that has recovered (9001), the cache manager (1021) sets the stop flag of the cache server that has recovered to off, the stop flag being registered in the cache server table (9002). Subsequently, the cache manager extracts the IP addresses of the plurality of PBR routers to which the cache server C that has recovered pertains in the nearby cache table, and creates the PBR router array (9003). Subsequently, the cache manager copies the head of the PBR router array to the variable PBR router “A” (9004), and deletes the head of the PBR router array (9005). Subsequently, the cache manager sets the variable n to 1 (9006). Subsequently, the cache manager determines whether the cache server C that has recovered has been registered as the n-th cache server, out of the PBR router “A” records registered in the nearby cache table (2022) (9007). When the cache server C that has recovered has not been registered, the cache manager adds 1 to the variable n (9008), and returns to the procedure 9007. When the cache server C that has recovered has been registered, the cache manager determines whether the allocation flag of the (n+1)-th cache server is on (9009). When the allocation flag is not on, the cache manager goes to the procedure 9012. When the allocation flag is on, the cache manager accesses the PBR router “A” by ssh, and alters the traffic forwarding destination of the PBR router “A” to the cache server C that has recovered (9010). Subsequently, the cache manager sets the allocation flag of the (n+1)-th cache server to off, and sets the allocation flag of the n-th cache server to on (9011). Subsequently, the cache manager sets the stop flag of the cache server C that has recovered to off (9012). Finally, the cache manager determines whether the PBR router array remains (9013). When the PBR router array remains, the cache manager returns to the processing 9004, whereas when the PBR router array does not remain, the cache manager ends processing (9014).

The processing described so far makes it possible to perform the recovery-handling processing of the cache server that has recovered to the present system.

Next, processing for adding a new cache server to the present system will be described. FIG. 14A is a flow chart of cache server addition request processing. After the start of cache server addition request processing (14001), the cache agent (1032, 1034, - - - ) transmits an addition request message to the cache manager (1021) (14002), and ends processing (14003). Here, the addition request message has such a form that the cache manager (1021) of the present system can confirm that the message is an addition request message made by the cache agent (1032, 1034), and that the IP address of the cache server to be added is included within the message. If the message can inform the cache manager (1021) of the request to register the cache server to be added in the cache server table (2023), the addition request message may have any form.

FIG. 14B is a flow chart of distance measurement processing. After the start of measurement processing of distance to the PBR router X (14004), the cache agent (1032, 1034) issues ping to the PBR router X (14005), and measures the distance. That is, the cache agent determines round trip time between target nodes by ping from time until a reply comes back. Subsequently, the cache agent returns a measurement result to the cache manager (1021) (14006), and ends processing (14007).

Here, FIG. 15 illustrates a specific example of the procedure 14005 of FIG. 14B. FIG. 15 is an example of ping issued from aaa.example.com [a1.a2.a3.a4] to zzz.example.com [z1.z2.z3.z4]. A result of ping indicates that an average distance of four measurements is 11 ms. This results in the distance of 11 ms. Although a ping program widely used as means for measuring distance is used here, another program having similar functionality may be used.

The above processing allows addition of a new cache server to the present system. Next, an example of deleting the cache server from the present system will be described.

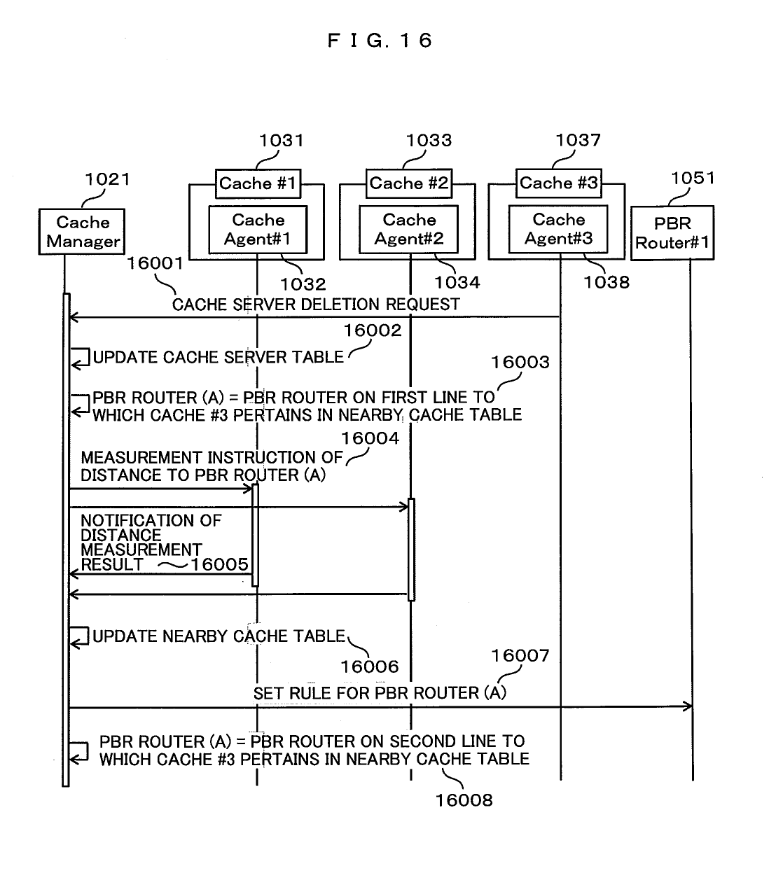

FIG. 16 illustrates sequence of cache server deletion processing for deleting the cache server from the present system. For example, in the embodiment of FIG. 16, it is assumed that the fourth cache server (1037) is deleted from the existing system in which the cache servers (1031, 1033, 1037) exist.

This processing is performed between the cache manager (1021) and all of the cache agents (1032, 1034, 1038). First, the cache agent (1038) that operates on the fourth cache server (1037) to be deleted sends a cache server deletion request (16001) to the cache manager (1021). Subsequently, the cache manager (1021) deletes the record regarding the cache server (1037) to be deleted from the cache server table (2023), and updates the cache server table (16002). Next, the cache manager (1021) extracts a plurality of lines regarding the cache server (1037) to be deleted in the nearby cache table (2022), creates a list, and extracts the PBR router on the first line of the list as the PBR router “A” (16003). Subsequently, the cache manager (1021) sends a measurement instruction of distance to the PBR router “A” (16004), to the cache agents (1032, 1034) of the cache servers (1031, 1033) other than the fourth cache server (1037) to be deleted. Subsequently, the cache manager (1021) receives distance measurement results from the cache agents (1032, 1034) (16005), and updates the nearby cache table by using the distance measurement results (16006). Subsequently, the cache manager (1021) sets a rule for the PBR router “A” (16007). After this, the cache manager performs processing from the procedure 16004 to the procedure 16007 repeatedly on a remaining part of the list.

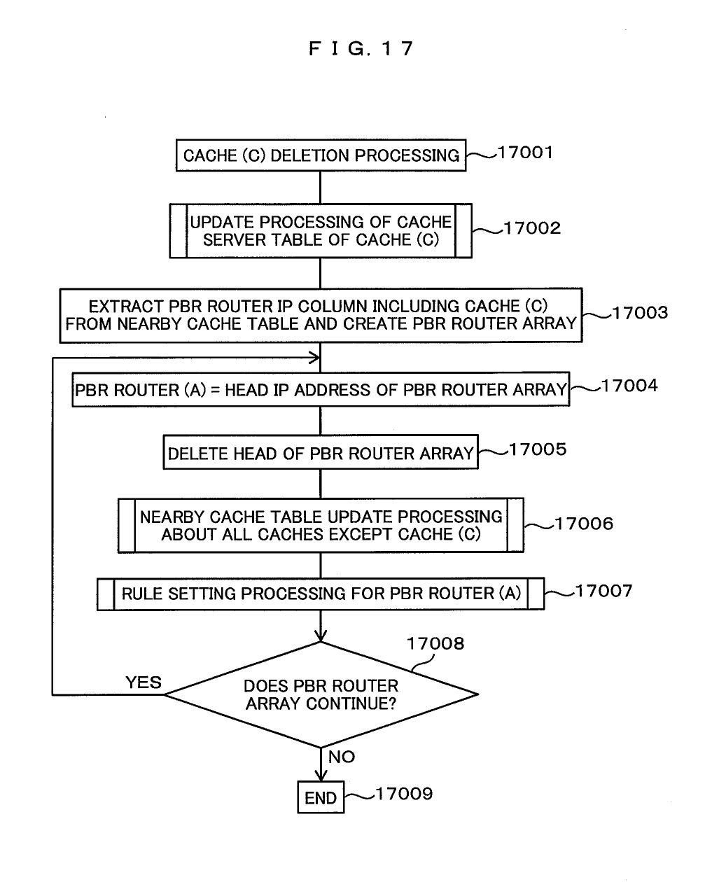

FIG. 17 illustrates a flow chart of processing part by the cache manager (1021) in the cache server deletion processing of FIG. 16. After the start of deletion processing of the cache server C (1037) (17001), the cache manager deletes the IP address of the cache server C from the cache server table (2023), and updates the cache server table (17002). Subsequently, the cache manager extracts the PBR router IP address column (2041) of all the records including the cache server C (1037) from the nearby cache table (2022), and creates the PBR router array (17003). Subsequently, the cache manager copies the head IP address of the PBR router array to the variable PBR router “A” (17004), and deletes the head of the PBR router array (17005). Subsequently, the cache manager (1021) performs nearby cache table update processing (17006) about all the cache agents (1032, 1034) other than the PBR router “A” and the cache server C, and performs rule setting processing for the PBR router “A” (17007). Subsequently, the cache manager (1021) determines whether the PBR router array remains (17008). If the PBR router array remains, the cache manager returns to the procedure 17004. If the PBR router array does not remain, the cache manager ends processing (17009).

The processing described so far allows deletion of the cache server from the present system. Next, processing for updating the rule that has been set for the PBR router of the present system will be described.

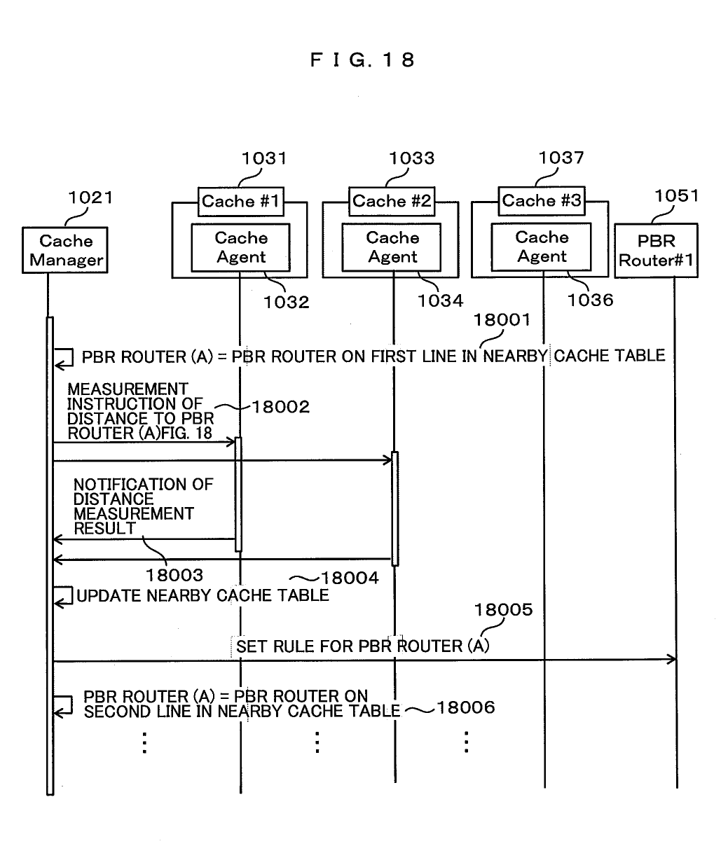

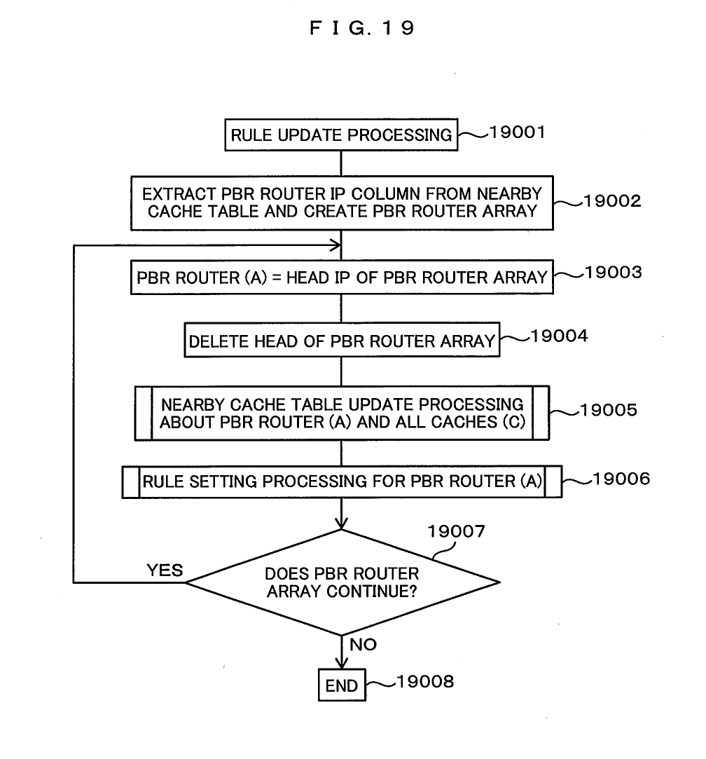

FIG. 18 illustrates sequence of rule update processing for updating the rule for all the PBR routers. The rule update processing can be implemented by performing processing (13003 to 13009) after the cache server table update processing in the cache server addition processing of FIG. 7. First, the cache manager (1021) extracts all PBR router IPs from the PBR router IP column (2041) in the nearby cache table (2022), and makes a list. The cache manager sets the PBR router on the first line of the list as the PBR router “A” (18001), and sends, to all the cache agents (1032, 1034, - - - ), a measurement instruction of distance to the PBR router “A” (18002). Subsequently, the cache manager (1021) receives distance measurement results from the cache agent (1032, 1034, - - - ) (18003), and updates the nearby cache table based on the results (18004). Subsequently, the cache manager sets a rule for the PBR router “A” (18005). After this, the cache manager continues the above processing on the remaining part in the list.

FIG. 19 illustrates a flow chart of a processing part by the cache manager (1021) in the rule update processing of FIG. 18. After the start (19001) of rule update processing, the cache manager (1021) extracts the PBR router IP address column (2041) of all the records from the nearby cache table (2022), and creates the PBR router array (19002). Subsequently, the cache manager copies the head of the PBR router array to the variable PBR router “A” (19003), and deletes the head of the PBR router array (19004). Subsequently, the cache manager (1021) performs nearby cache table update processing (19005) about the PBR router “A” and each of the cache agents (1032, 1034, - - - ) that operate on all the cache servers (1031, 1033, - - - ), and next performs rule setting processing for the PBR router “A” (19006). Subsequently, the cache manager (1021) determines whether the PBR router array continues (19007). If the PBR router array continues, the cache manager returns to the procedure 19003. If the PBR router array does not continue, the cache manager ends processing (19008). Note that some variations can be considered as a trigger for performing the rule update processing. For example, each cache agent (1032, 1034, - - - ) monitors the network configuration. When a change in the network configuration is detected, the cache agent (1032, 1034) performs notification of network configuration change detection to the cache manager (1021). It is considered that the cache manager (1021) updates the rule with the trigger of this notification.

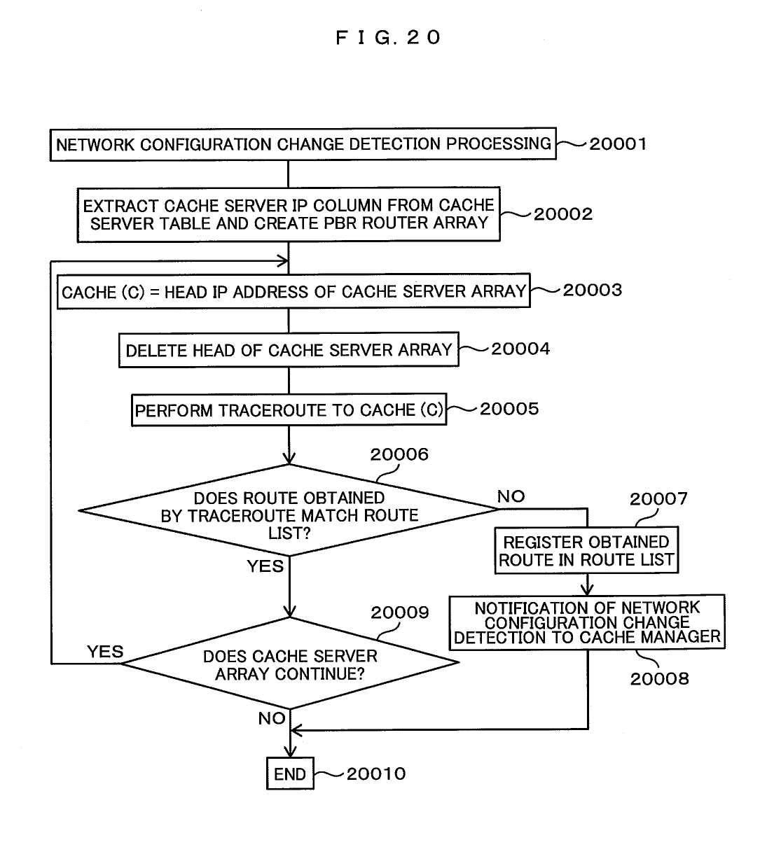

A flow chart of network configuration change detection processing by each cache agent (1032, 1034, - - - ) is as illustrated in FIG. 20.

FIG. 20 is a flow chart of network configuration change detection processing by each cache agent (1032, 1034, - - - ). First, after the start of network configuration change detection processing (20001), the cache agent extracts the cache server IP column from the cache server table (2023), and creates the cache server array (20002). Subsequently, the cache agent substitutes the head IP address of the cache server array for the changed cache server C (for example, cache server 1037) (20003). Subsequently, the cache agent deletes the head of the cache server array (20004). Subsequently, the cache agent performs “traceroute” to the cache server C (20005). A network route is listed by this “traceroute” command. Subsequently, the cache agent determines whether the route obtained as a result of “traceroute” matches the route registered in a route list (20006). When these routes do not match each other, the cache agent newly registers the obtained route in the route list (20007), and sends a notification of network configuration change detection to the cache manager (1021) (20008). When these routes match each other, the cache agent determines whether the cache server array continues (20009). If the cache server array continues, the cache agent returns to the procedure 20003. If the cache server array does not continue, the cache agent ends processing (20010). Although the “traceroute” program widely used as means for acquiring a route is used here, another program having similar functionality may be used.

Other methods of detecting changes in the network configuration include a method of using existing fault detection systems (for example, the fault detection system described in http://h50146.www5.hp.com/products/software/oe/hpux/component/ha/serviceguard_A_{—}11_{—}20.html) and detecting changes with an alert from the system. Other existing fault detection devices or fault detection methods capable of detecting a fault or a change in the network configuration can substitute for this method.

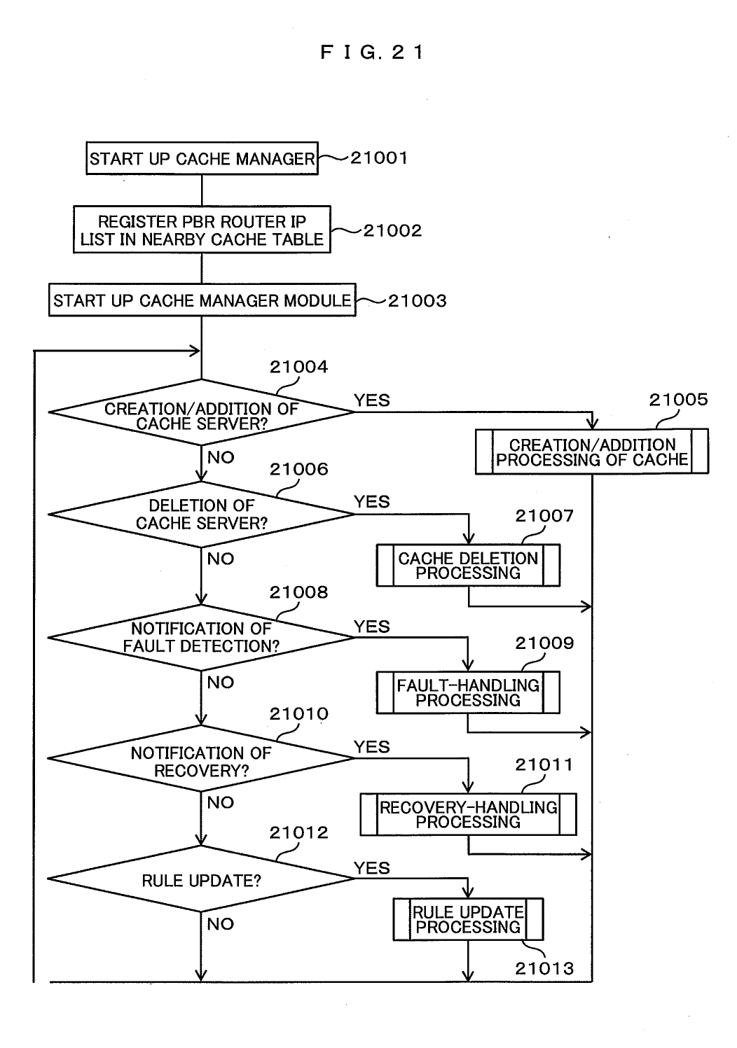

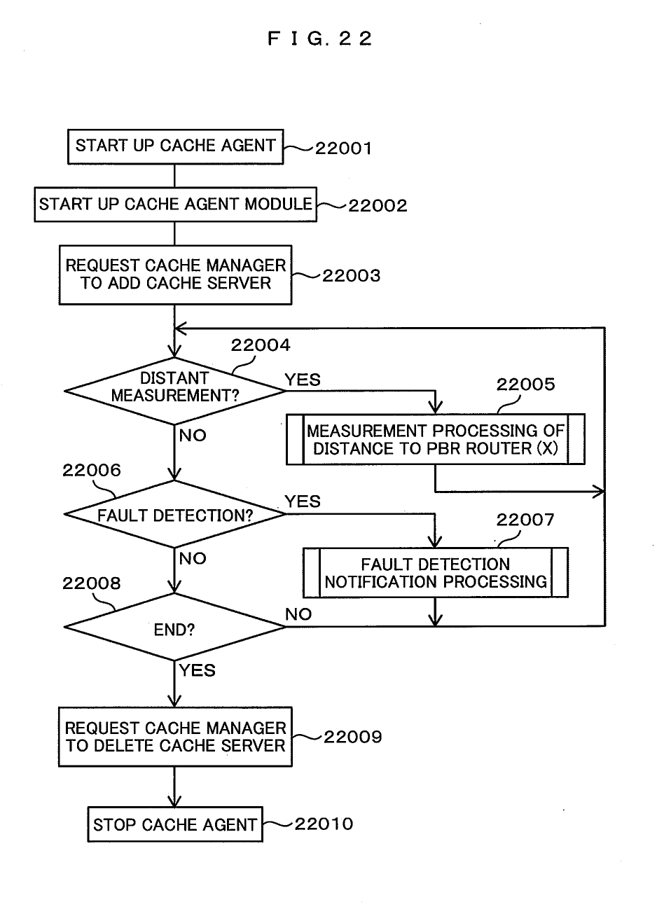

Finally, with the individual procedures described so far being integrated, FIG. 21 illustrates an operation of the cache manager (1021), and FIG. 22 illustrates an operation of each cache agent (1032, 1034, - - - ).

FIG. 21 is a flow chart of the operation of the cache manager. After the start-up (21001), the cache manager (1021) registers the IP addresses of the PBR routers in the nearby cache table (2022) (21002). This is a list of the PBR router IP addresses provided as initial values, and is input manually here. Besides this, a method of writing the IP addresses in a configuration file can be considered. Subsequently, the cache manager (1021) starts up the cache manager module (2021) (21003), and waits for a request for processing after this. When there is a request for addition of a cache server (21004), the cache manager performs addition processing of the cache server of FIG. 7 (21005). When there is a request for deletion of a cache server (21006), the cache manager performs deletion processing of the cache server of FIG. 17 (21007). When there is a notification of fault detection from any one of the cache agents (1032, 1034, - - - ) (21008), the cache manager performs fault-handling processing of the cache server of FIG. 10 (21009). Here, the fault shall include changes in the network configuration or the like, in addition to device failures or the like. Detection of such changes or failures shall be detection of a fault.

In the present embodiment, each cache agent (1032, 1034, - - - ) detects a fault at the cache server. However, it is also possible to periodically execute the ping command from the cache manager (1021) to the cache server (1032, 1034, - - - ), and to detect a case where there is no response to the ping command from any cache server (1032, 1034, - - - ) as a fault. Here, the cache manager (1021) uses the ping command in order to confirm that the cache server (1032, 1034, - - - ) has survived. However, any means that allows the cache manager (1021) to confirm that the cache server (1032, 1034, - - - ) has survived can substitute for the ping command. When there is a notification of recovery of the cache server from each cache agent (1032, 1034, - - - ) (21010), the cache manager performs recovery-handling processing of the cache server of FIG. 13 (21011). In addition, when a trigger event for rule update arises (21012), the cache manager performs rule update processing of FIG. 19 (21013).

FIG. 22 is a flow chart of the operation of each cache agent (1032, 1034, - - - ). After the start-up (22001), the cache agent starts up the cache agent module (22002), and requests the cache manager (1021) to add a cache server (22003). The cache agent waits for a request for processing after this. When there is a request for distance measurement (22004), the cache agent performs measurement processing of distance to the PBR router X of FIG. 14B (22005). In addition, when the cache agent detects a fault at the cache server on which the cache agent itself operates (22006), the cache agent performs fault detection notification processing of FIG. 11 (22007). When there is an explicit end instruction from an administrator while waiting for a request (22008), the cache agent sends a cache server deletion request to the cache manager (1021) (22009) and stops each cache agent (1032, 1034) (220010).

The above processing allows the cache agent to perform cache server fault-handling processing, cache server recovery-handling processing, cache server addition processing, cache server deletion processing, and rule update processing.

The configuration of FIG. 1 using the cache manager (1021) and cache agents (1032, 1034, - - - ) that implement the above procedures makes it possible, when a fault arises at any one of the cache servers, to forward traffic of an end user to another cache server close in terms of distance to the cache server at which the fault has arisen, and allows the end user to use the cache server continuously. Furthermore, with a trigger being notification of fault detection at the cache server, each cache agent (1032, 1034, - - - ) can automatically process alteration processing of the traffic forwarding destination of the PBR router.

As an example of application of the present embodiment, the automatic-fault-handling cache system includes one set of cache manager, several thousand sets of PBR routers, and about 100 to 1,000 sets of cache servers. That is, when the present embodiment is compared with, for example, the conventional method described in Patent Literature 1, the present embodiment needs to newly provide one set of cache manager on the system. However, while it is conventionally necessary to provide many backup cache servers that have a fixed relationship with the active cache servers, such as in the relationship of one to one, or one to two or more (single digit), the present embodiment manages backup cache servers dynamically, and thus does not have such restrictions. Even when a large number of cache servers are present on a network, all the cache servers can be effectively used with one set of cache manager. That is, according to the present embodiment, without preparing backup cache servers for cache servers or load balancers in advance, the relationship between each of the cache servers and each of the backup cache servers can be dynamically managed through the use of a database. Namely, a cache server close in terms of distance to a PBR router that is forwarding traffic to a cache server at which a fault has arisen can be extracted from the database, and can be used as a backup cache server.

If there are, for example, 1,000 sets of cache servers on the network, each of the cache servers can function as a backup cache server for other cache servers.

Even when a fault arises in one cache server, this configuration allows the end user to use another cache server continuously, and can guarantee an SLA with respect to the end user. Moreover, since the backup cache server or the load balancer, that has a fixed relationship with the cache server, becomes unnecessary, this can contribute to reduction in the facility costs incurred by the cache system manager and to reduction in the operating costs that attends maintenance.

### Embodiment 2

The present embodiment is a variation of embodiment 1, and describes an example in which cache server fault-handling processing, cache server recovery-handling processing, cache server addition processing, cache server deletion processing, and rule update processing, performed by the cache manager device in embodiment 1, are performed by one of the plurality of cache agents as a representative. It is assumed that the cache agent operates on the cache server. In this case, the cache manager device is characterized by operating as a device that selects the representative cache agent that performs the above processing. Therefore, the present embodiment alters the configuration of each of the cache manager and the cache agent, and the operation of each of the cache manager and the cache agent, in accordance with characteristics described above. Other configurations of the present embodiment are identical to the configurations of FIG. 1 of embodiment 1.

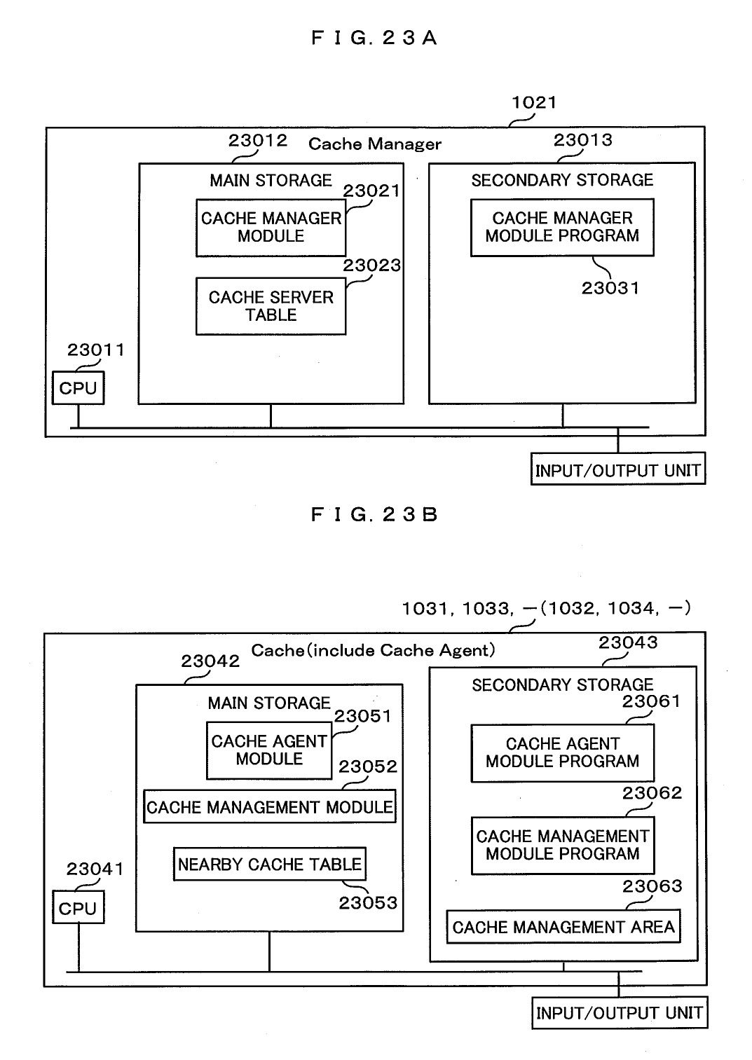

FIG. 23A and FIG. 23B illustrate the detailed configurations of a cache manager (1021) and the cache servers of the present embodiment, respectively. In FIG. 23A, the cache manager (1021) includes a CPU (23011), a main storage (23012), and a secondary storage (23013). The main storage (23012) includes a cache manager module (23021) and a cache server table (23022). The cache manager module (23021) is a run-time image of a program for controlling the cache manager (1021). Detailed operation of the cache manager module (23021) will be described later. In addition, the cache server table (23023) is a list of the cache servers that exist on the network.

In FIG. 23B, each cache server (1031, 1033, - - - ) includes a CPU (23041), a main storage (23042), and a secondary storage (23043). The main storage (23042) includes a cache agent module (23051), a cache management module (23052), and a nearby cache table (23053). The cache agent module (23051) is a run-time image of a program for controlling each cache agent (1032, 1034, - - - ). Detailed operation of the cache agent module (23051) will be described later. The cache management module (23052) is a run-time image of a program for caching and distributing content. The secondary storage (23043) includes a cache agent module program (23061), a cache management module program (23062), and a cache management area (23063). During cache agent (1032, 1034) operation, the cache agent module program (23061) is developed on the main storage (23042), and is executed as the cache agent module (23051). During cache server (1031, 1033, - - - ) operation, the cache management module program (23062) is developed on the main storage (23042), and is executed as the cache management module (23052). In the present embodiment, a general-purpose program is used as the cache management module program (23062). The cache management area (23063) is an area that the cache management module (23052) manages, and is an area in which content is cached. As the nearby cache table (23053), a nearby cache table identical to the nearby cache table of FIG. 3 of embodiment 1 is used.

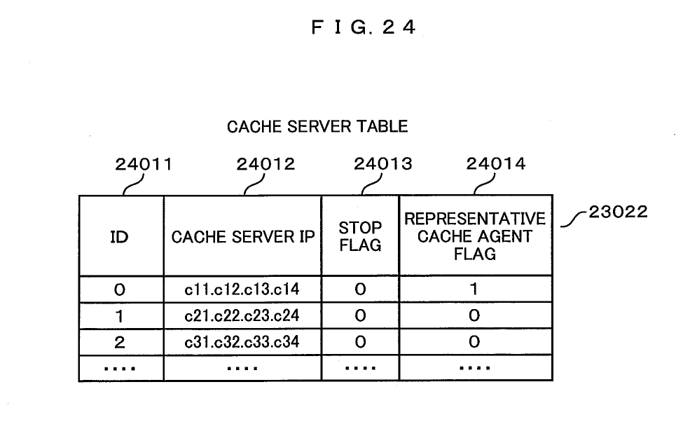

FIG. 24 illustrates details of the cache server table. The cache server table (23022) includes an ID column (24011) that is serial numbers, a cache server IP address column (24012) that is identification information on the cache servers, a stop flag column (24013) that represents whether each cache server has stopped, and a representative cache agent flag column (24014) that represents whether each cache agent is a representative cache agent. Here, the IP address that is identification information on the cache server is unique to the cache server device. The stop flag is identical to the stop flag in the cache server table (2023) of embodiment 1. When either of the cache agents (1032, 1034, - - - ) that operates on the cache server is a representative cache agent, the representative cache agent flag is set to 1 as on. When neither of the cache agents (1032, 1034, - - - ) that operates on the cache server is a representative cache agent, the representative cache agent flag is set to 0 as off. In addition, the primary key of the cache server table (23022) is the ID column (24011), and one specific line can be determined by using the ID column. In addition, the cache server IP address column (24012) is also a unique column, and one specific line can be determined by using the cache server IP address column. The secondary storage (23013) includes a cache manager module program (23031). During cache manager (1021) operation, the cache manager module program (23031) is developed on the main storage (23012) and is executed as the cache manager module (23021).

Next, the operation of the present embodiment will be described.

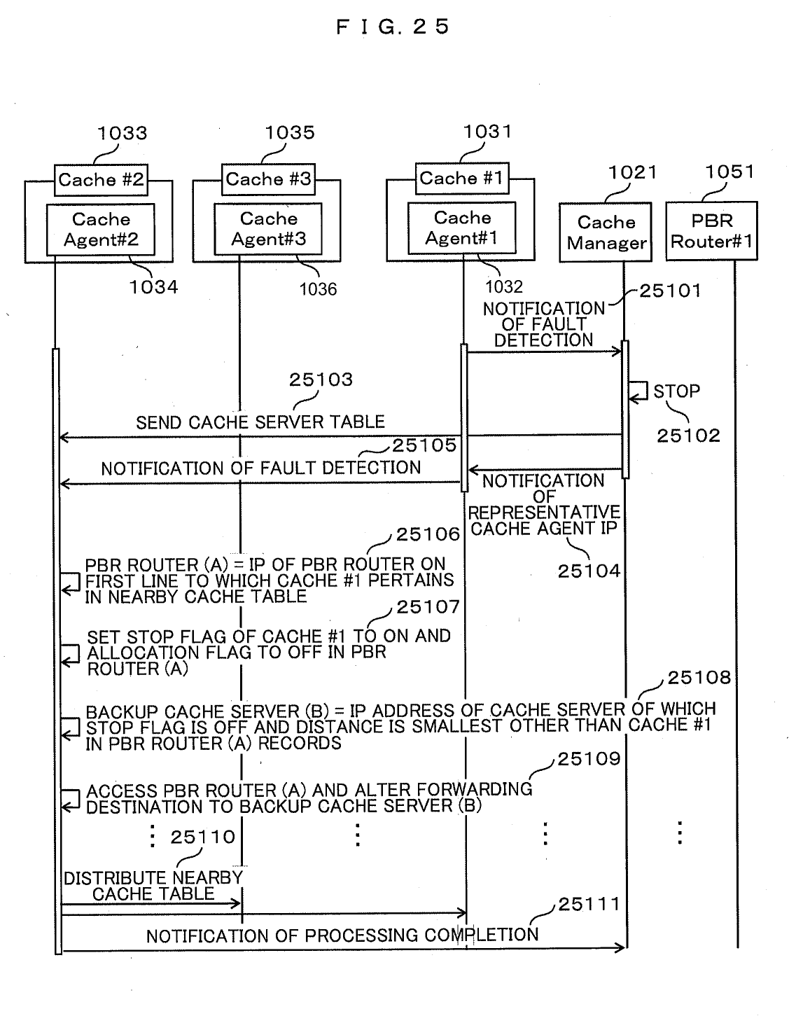

FIG. 25 illustrates cache server fault-handling processing sequence performed when the Cache Agnet (1032, 1034, - - - ) detects a fault at the cache server in the present system. Here, an example will be described in which a fault arises at the cache server (1031) and the cache agent (1034) functions as a representative cache agent in the system configuration of FIG. 1. The present processing is performed among the cache agent (1032) that operates on the cache server (1031) at which the fault has arisen, the cache manager (1021), and the representative cache agent (1034) selected by the cache manager. First, the cache agent (1032) that operates on the cache server (1031) at which the fault has arisen sends a notification of fault detection to the cache manager (1021) (25101). Subsequently, the cache manager (1021) sets the stop flag in the record of the cache server (1031) at which the fault has arisen to on, the stop flag being registered in the cache server table (23022) (25102). Subsequently, the cache manager (1021) acquires the IP address of the cache server of which the representative cache agent flag is on in the cache server table (23022), and sends the cache server table to the representative cache agent (1034) (25103). Subsequently, the cache manager (1021) notifies the cache agent (1032) that has sent the notification of fault detection, of the IP address of the representative cache agent (1034) (25104). Subsequently, the cache agent (1032) sends the notification of fault detection to the representative cache agent (1034) notified by the cache manager (1021) (25105). Subsequently, the representative cache agent (1034) extracts the plurality of PBR router IPs to which the cache server (1031) at which the fault has arisen pertains, from the PBR router IP column (3011) in the nearby cache table (2022), makes a list, and sets the PBR router on the first line in this list as the PBR router “A” (25106). Next, the representative cache agent (1034) sets the stop flag of the cache server (1031) at which the fault has arisen to on in the PBR router “A” record, and sets the allocation flag to off (25107). Furthermore, the representative cache agent (1034) extracts, from the nearby cache table (2022), the cache server IP of which the distance is the smallest and the stop flag is off other than the cache server at which the fault has arisen in the PBR router “A” record, and sets the cache server IP as the backup cache server B (25108). Finally, the representative cache agent (1034) accesses the PBR router “A” and alters the traffic forwarding destination to the backup cache server B via a command line (25109). After this, the above processing is continued on a remaining part of the list. Finally, the representative cache agent (1034) distributes the nearby cache table that the representative cache agent itself has to all of the cache agents (1036, 1032) (25110), and sends a notification of processing completion to the cache manager (1021) (25111).

As described above, in the present system, the cache manager (1021) selects one representative cache agent from among the plurality of cache agents (1032, 1034, - - - ), and the representative cache agent performs cache server fault-handling processing. Cache server fault-handling processing, cache server recovery handling processing, cache server addition processing, cache server deletion processing, and rule update processing performed by the representative cache agent are identical to processing performed by the cache manager (1021) of embodiment 1, and the flow charts are also identical. However, the present embodiment is different from embodiment 1 in that the representative cache agent needs to distribute the nearby cache table to all of the cache agents other than the representative cache agent itself after the completion of processing, and to send the notification of processing completion to the cache manager. Although the cache manager device is installed in the present embodiment, the present embodiment can also be implemented by not installing the cache manager as one device, but by causing, for example, a DNS server to select the representative cache agent.

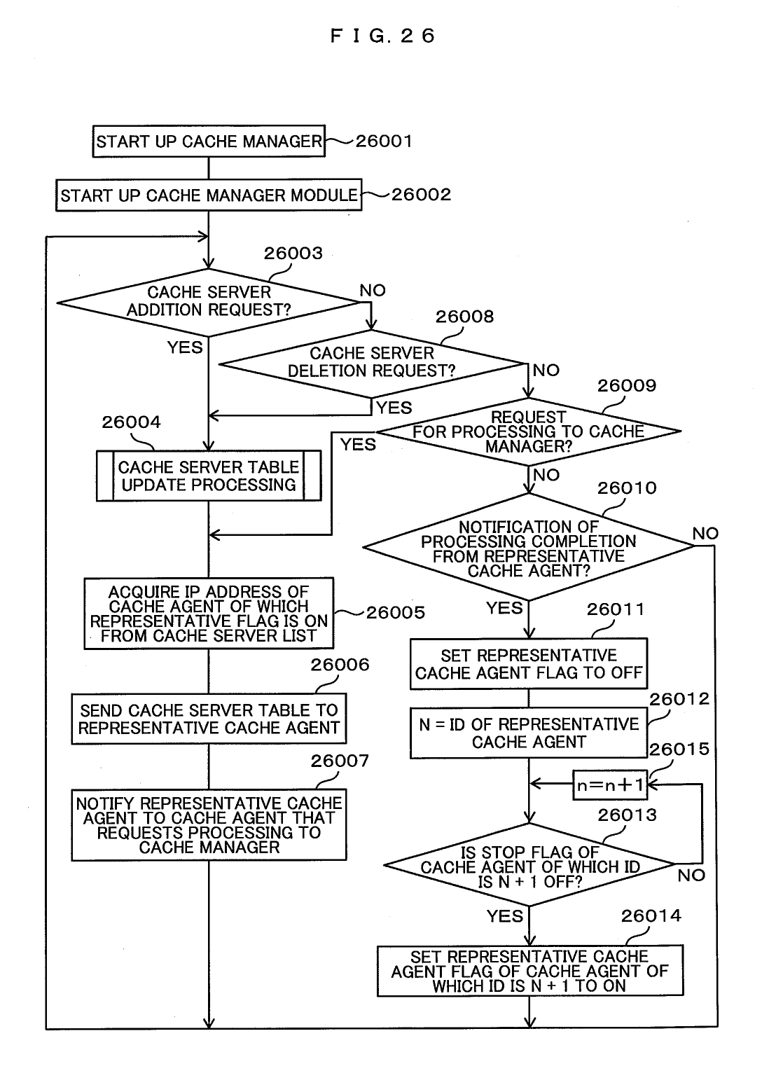

FIG. 26 is a flow chart of overall operation of the cache manager. After the start-up (26001), the cache manager (1021) starts up the cache manager module (23021) (26002), and waits for a request for processing after this. When there is a cache server addition request (26003), the cache manager (1021) performs cache server table update processing of FIG. 6A of embodiment 1 (26004). Subsequently, the cache manager (1021) acquires the IP address of the cache agent of which the representative cache agent flag is on from the cache server table (26005), and sends the cache server table to the representative cache agent (1034) (26006). Subsequently, the cache manager (1021) notifies the IP address of the representative cache agent to the cache agent that sends the cache server addition request or a deletion request (26007). When there is a processing request other than the cache server addition request or deletion request (26009), the cache manager (1021) determines whether there is any notification of processing completion from the representative cache agent (26010). When there is a notification of processing completion, the cache manager (1021) sets the representative cache agent flag in the cache server table to off (26011). Subsequently, the cache manager (1021) substitutes the ID of the representative cache agent for the variable n (26012), and determines whether the stop flag of the cache agent of which ID is n+1 is off (26013). When the stop flag is off, the cache manager (1021) sets the representative cache agent flag of the cache agent of which ID is n+1 to on (26014). When the stop flag is not off, the cache manager (1021) adds 1 to n (26015), and returns to the procedure 26013.

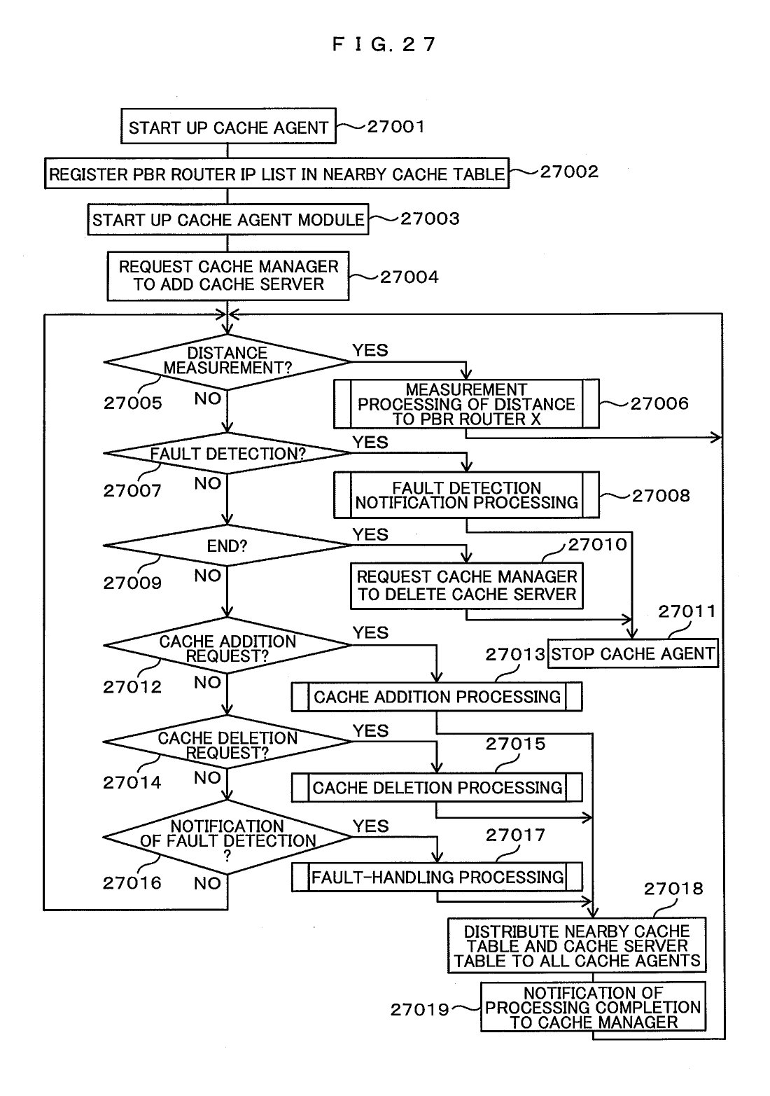

FIG. 27 is a flow chart of overall operation of the cache agent. After the start-up (27001), each of the cache agents (1032, 1034, - - - ) registers the IP addresses of the PBR routers in the nearby cache table (2022) (27002). This is a list of the PBR router IP addresses provided as initial values, and is input manually here. Besides this, a method of writing the IP addresses in a configuration file can be considered. Subsequently, the cache agent starts up the cache agent module (23021) (27003), and requests the cache manager (1021) to add the cache server (27004). After this, the cache agent waits for a request for processing. When there is a distance measurement request (27005), the cache agent performs measurement processing of distance of FIG. 14 (B) of embodiment 1 (27006). When a fault at the cache server is detected (27007), the cache agent performs the fault detection notification processing of FIG. 11 of embodiment 1 (27008), and stops the cache server (27011). When the administrator explicitly instructs to end processing (27009), the cache agent requests the cache manager (1021) to delete the cache server (27010), and stops the cache server (27011). When there is a cache server addition request from a cache agent other than the cache agent itself (27012), the cache agent performs the cache server addition processing of FIG. 7 of embodiment 1 (27013). After the processing completion, the cache agent distributes the nearby cache table to all of the cache agents other than the cache agent itself (27018), and sends a notification of processing completion to the cache manager (1021) (27019). Subsequently, the cache agent-returns to the procedure 27005. In addition, when there is a cache server deletion request from a cache agent other than the cache agent itself (27014), the cache agent performs the cache server deletion processing of FIG. 17 of embodiment 1 (27015). After the processing completion, the cache agent distributes the nearby cache table to all of the cache agents other than the cache agent itself (27018), and sends the notification of processing completion to the cache manager (1021) (27019). Subsequently, the cache agent returns to the procedure 27005. Furthermore, when there is a notification of cache server fault detection from a cache agent other than the cache agent itself (27016), the cache agent performs the cache server fault-handling processing of FIG. 10 of embodiment 1 (27017). After the processing completion, the cache agent distributes the nearby cache table to all of the cache agents other than the cache agent itself (27018), and sends the notification of processing completion to the cache manager (1021) (27019). Subsequently, the cache agent returns to the procedure 27005.

As described above, in the present embodiment, the cache manager (1021) selects one representative cache agent from the plurality of cache agents (1032, 1034, - - - ), and the representative cache agent performs cache server fault-handling processing. Since the representative cache agent performs the operations identical to the operations of the cache manager (1021) of embodiment 1, the flow charts of cache server fault-handling processing, recovery handling processing, addition processing, deletion processing, and rule update processing are identical to the flow charts of embodiment 1. However, the present embodiment is different from embodiment 1 in that the representative cache agent needs to distribute the nearby cache table to all of the cache agents other than the representative cache agent itself after the completion of processing, and to send the notification of processing completion to the cache manager.

Even when a fault has arisen at one cache server, the present embodiment also allows end users to continue to use other cache servers, guarantees an SLA with respect to the end users, and can also contribute to reduction in the facility costs and operating costs incurred by the cache system managers.

### REFERENCE SIGNS LIST

1011 . . . network

1021 . . . cache manager

1031, 1033, 1035 . . . cache server

1032, 1034, 1036 . . . cache agent

1041 to 1043 . . . router

1051 to 1053 . . . PBR (Policy Based Routing) router

1061 to 1064 . . . PC

2011 . . . CPU

2012 . . . main storage

2013 . . . secondary storage

2021 . . . cache manager module

2022 . . . nearby cache table

2023 . . . cache server table

2041 . . . CPU

2042 . . . main storage

2043 . . . secondary storage

2051 . . . cache agent module

2052 . . . cache management module

2061 . . . cache agent module program

2062 . . . cache management module program

2063 . . . cache management area

1. An automatic-fault-handling cache system comprising, on a network:
one cache manager;
a plurality of cache servers;
cache agents operating on the cache servers, respectively;
a database; and
at least one PBR routers,
wherein the database comprises:
a first database comprising identification information and a serial number of each of the cache agents; and
a second database comprising identification information on each of the PBR routers and identification information on each of the cache servers that is close in terms of distance to each of the PBR routers,
wherein each of the cache agents comprises functionality of, with a trigger being detection of a fault at a first cache server, sending a notification of fault detection describing detection of the fault at the first cache server and identification information on the first cache server to the cache manager,
wherein the cache manager comprises:
functionality of acquiring, from the database, identification information on a first PBR router in which the identification information on the first cache server at which the fault is detected is registered as each of the cache servers close in terms of distance;
functionality of acquiring, from the database, identification information on a second cache server registered as each of the cache servers close in terms of distance to the first PBR router; and
functionality of accessing the first PBR router and altering a traffic forwarding destination of the first PBR router to the second cache server.

2. The automatic-fault-handling cache system according to claim 1, wherein
the second database comprises information regarding a load of each of the cache servers, and
the cache manager comprises functionality of selecting, based on information in the second database, each of the cache servers having the distance to the first PBR router equal to or less than a predetermined value and the small load, as the second cache server that is the traffic forwarding destination of the first PBR router forwarding traffic to the first cache server.

3. The automatic-fault-handling cache system according to claim 1, wherein
the second database comprises information regarding a load and priority of each of the cache servers, and
the cache manager comprises functionality of selecting, based on information in the second database, each of the cache servers having the distance to the first PBR router equal to or less than a predetermined value, the small load, and the high priority, as the second cache server that is the traffic forwarding destination of the first PBR router forwarding traffic to the first cache server.

4. The automatic-fault-handling cache system according to claim 1, wherein
information in the second database is comprised as a nearby cache table,
the nearby cache table comprises:
an IP address for identifying each of the PBR routers on the network;
an IP address of each of the cache servers;
the distance from each of the PBR routers to each of the cache servers;
a stop flag representing whether each of the cache servers has stopped;
an allocation flag column representing whether each of the cache servers has been allocated as the traffic forwarding destination of each of the PBR routers;
a CPU usage rate of each of the cache servers; and
information on priority of each of the cache servers,
wherein the cache manager selects the second cache server based on the information in the nearby cache table.

5. The automatic-fault-handling cache system according to claim 1, wherein each of the cache agents comprises, as means for detecting presence of change in a configuration of the network:
functionality of extracting a cache server IP column from the first database to create a cache server array;
functionality of substituting a head IP address of the cache server array for a variable cache server, performing means for acquiring a route to the variable cache server, and determining whether the resulting route matches a route registered in a route list;
functionality of newly registering the resulting route in the route list when a result of the determination does not match; and
functionality of performing notification of change detection in the network configuration to the cache manager.

6. The automatic-fault-handling cache system according to claim 1, wherein
the cache manager comprises the first database and the second database, and
the cache agents that operate on the cache servers perform fault-handling processing regarding the cache servers, respectively.

7. The automatic-fault-handling cache system according to claim 4, wherein
the cache manager comprises the first database,
each of the cache agents comprises the second database,
the nearby cache table comprises information that indicates whether each of the cache agents that operates on each of the cache servers is a representative cache agent,
the representative cache agent performs, as a representative, fault-handling processing for performing fault-handling processing regarding the plurality of cache servers on the network, and
the representative cache agent distributes the nearby cache table to all of the cache agents other than the representative cache agent itself after completion of the fault-handling processing, and performs notification of processing completion to the cache manager.

8. The automatic-fault-handling cache system according to claim 4, wherein each of the cache agents:
performs recovery-handling processing, addition processing, deletion processing, or rule update processing of each of the cache servers; and
updates the nearby cache table automatically in each processing step.

9. A fault-handling processing method for a cache server in a cache system,
wherein the cache system comprises, on a network:
one cache manager;
a plurality of cache servers;
cache agents operating on the cache servers, respectively;
a database; and
at least one PBR routers,
wherein the database comprises:
a first database comprising identification information and a serial number of each of the cache agents; and
a second database comprising identification information on each of the PBR routers and identification information on each of the cache servers that is close in terms of distance to each of the PBR routers,
the fault-handling processing method comprising steps of:
a first step of sending, by one of the cache agents, with a trigger being detection of a fault at a first cache server, a notification of fault detection describing detection of the fault at the first cache server and identification information on the first cache server to the cache manager;
a second step of acquiring from the database, by the cache manager, identification information on a first PBR router in which the identification information on the first cache server at which the fault is detected is registered as each of the cache servers close in terms of distance;
a third step of acquiring from the database, by the cache manager, identification information on a second cache server registered as each of the cache servers close in terms of distance to the first PBR router; and
a fourth step of accessing, by the cache manager, the first PBR router and altering a traffic forwarding destination of the first PBR router to the second cache server.

10. The fault-handling processing method for a cache server in a cache system according to claim 9, wherein
information in the second database is comprised as a nearby cache table,
the nearby cache table comprises:
an IP address for identifying each of the PBR routers on the network;
an IP address of each of the cache servers;
the distance from each of the PBR routers to each of the cache servers;
a stop flag representing whether each of the cache servers has stopped;
an allocation flag column representing whether each of the cache servers has been allocated as the traffic forwarding destination of each of the PBR routers; and
information regarding a load of each of the cache servers,
wherein the cache manager selects each of the cache servers having the distance to the first PBR router equal to or less than a predetermined value, and the small load, as the second cache server.

11. The fault-handling processing method for a cache server in a cache system according to claim 10, wherein
the nearby cache table comprises information regarding priority of each of the cache servers, and
the cache manager selects each of the cache servers having the distance equal to or less than the predetermined value, the small load, and the high priority, as the second cache server.

12. The fault-handling processing method for a cache server in a cache system according to claim 9, wherein
the cache manager comprises the first database and the second database, and
the cache agents that operate on the cache servers perform fault-handling processing regarding the cache servers, respectively.

13. The fault-handling processing method for a cache server in a cache system according to claim 9, wherein
the cache manager comprises the first database,
each of the cache agents comprises the second database,
the nearby cache table comprises information that indicates whether each of the cache agents that operates on each of the cache servers is a representative cache agent,
the representative cache agent performs, as a representative, fault-handling processing for performing fault-handling processing regarding the plurality of cache servers on the network, and
the representative cache agent distributes the nearby cache table to all of the cache agents other than the representative cache agent itself after completion of the fault-handling processing, and performs notification of processing completion to the cache manager.

14. A cache manager connected to a network,
the network comprising:
a plurality of cache servers;
cache agents operating on the cache servers, respectively;
a database; and
at least one PBR routers,
the database comprising:
a first database comprising identification information and a serial number of each of the cache agents; and
a second database comprising identification information on each of the PBR routers and identification information on each of the cache servers that is close in terms of distance to each of the PBR routers,
the cache manager comprising:
functionality of receiving a notification of fault detection describing detection of a fault at a first cache server and identification information on the first cache server, from each of the cache agents on the network;
functionality of acquiring, from the database, identification information on a first PBR router in which identification information on the first cache server at which the fault is detected is registered as each of the cache servers close in terms of distance;
functionality of acquiring, from the database, identification information on a second cache server registered as each of the cache servers close in terms of distance to the first PBR router; and
functionality of accessing the first PBR router and altering a traffic forwarding destination of the first PBR router to the second cache server.

15. The cache manager according to claim 14, wherein
the second database comprises information regarding a load and priority of each of the cache servers, and
the cache manager comprises functionality of selecting, based on information in the second database, each of the cache servers having the distance to the first PBR router equal to or less than a predetermined value, the small load, and the high priority, as the second cache server that is the traffic forwarding destination of the first PBR router forwarding traffic to the first cache server.
